(19) United States
(12) Patent Application Publication
(10) Pub. No.: US 2024/0135031 A1
(43) Pub. Date: Apr. 25, 2024

(54) SYSTEM FOR ANONYMOUS COHORT-MATCHED CONTENT DELIVERY

(71) Applicant: Persona Health, Inc. dba Dragonfly Data Ventures, Inc., South Glastonbury, CT (US)

(72) Inventor: John HEALY, Acton, MA (US)

(21) Appl. No.: 18/382,222

(22) Filed: Oct. 19, 2023

Related U.S. Application Data
(60) Provisional application No. 63/380,288, filed on Oct. 20, 2022.

(51) Int. Cl. G06F 21/62

(52) U.S. Cl. CPC G06F 21/6245

(57) ABSTRACT

A system and method are provided to enable commercial and personal data use cases by implementing comparison methods that are applied to an entirely anonymous version of the underlying user data. The system architecture allows for anonymization of input user identifying data to uniquely protect that data while making attribute information regarding groups of users available for other entities to access in a manner that allows the other entities to target groups of users according to the attribute information. A unique level of compartmentalization of anonymous and non-anonymous data including temporal and geographic anonymization barriers is provided. The processes enable the system to continually learn and improve its ability to perform cohort discovery, cohort-matching and cohort-matched content delivery in an entirely anonymous data space are also specified. Lastly, the architecture, processes and user incentives provide necessary components to render the closed loop system continually updateable with user's longitudinal data.

This application claims the benefit of U.S. Provisional Patent Application No. 63/380,288, entitled “System for Anonymous Cohort-Matched Content Delivery,” filed Oct. 20, 2022, the disclosure of which is hereby incorporated by reference herein in its entirety.

### BACKGROUND

### 1. Field of the Disclosure

This disclosure is directed to exemplary embodiments of systems, and methods, techniques, processes and/or operating scenarios by which federated learning, privacy-enhanced computing, portable health records, and decision support are implemented.

### 2. Description of the Related Art

Commercial entities look to continually enhance their ability to predict to which people they should market their products and services. As social media companies, large search engines and retail giants have demonstrated, this can only be accomplished by some form of cohort matching among prospective customers. Historically, this matching process has sacrificed privacy in exchange for expedience.

The preponderance of existing systems that exhibit many of the following weaknesses:
1. Data is siloed and fractured—
   a. Many data aggregators attempt to “own” a copy of the subset of data that is already stored.
   b. Any particular aggregator only sees a small percentage of the whole picture for any individual user.
2. Data is stale—
   a. Most data aggregation systems are not in a closed loop.
   b. Connections to the data producer (“consumer”) are transient.
3. data has low independent value
   a. most data points are copied and distributed to many “owners”
4. consumer privacy is frequently compromised
5. data is incoherent
   a. There is no common data dictionary across silos
6. existing incentives are lopsided
   a. The most compelling incentives belong to the aggregators
   b. Little, if any, incentives for an individual data producer
7. existing incentives perpetuate these failings
   a. 6(a) means it has been easy to justify any effort to create another silo
   b. 6(b) leads directly to the failing of data staleness

### SUMMARY OF THE DISCLOSED EMBODIMENTS

In view of the clear need, and easily identifiable shortfalls in currently available systems, it would be advantageous to provide a data management system particularly tailored to information sharing while protecting data that identifies individual users, particularly private individuals.

Embodiments according to this disclosure are intended to address any or all of the weaknesses detailed above as shortfalls in the prior art. Embodiments may enable one or more of the following capabilities:
1. private individuals (“users”) may secure any and all data that identifies the private individuals;
2. users may passively aggregate and secure all data the users generate through daily activities, including, but not limited to, data that may be characterized as behavioral, biometric, or transactional in nature for the users;
3. untrusted third parties may be afforded a mechanism by which to reach out to the users, individually or in targeted groupings, without violating the privacy of the users or knowing the identities of the users;
4. commercial entities may be provided a mechanism by which to engage in highly targeted marketing campaigns without ever accessing any particular, or group of, users' private or identifying data; and
5. trusted third parties, such as physicians, may be identified and provided a mechanism for access to private data by the users.

Embodiments may maximize the utility of data generated by private entities, in perpetuity, without compromising the data privacy of those same entities.

Embodiments may enable all known routine and/or commonplace data utilization, whether private or commercial, to occur in an anonymous data space, while simultaneously enabling identified elements of private data to be passively aggregated, secured and anonymized in a closed loop scheme providing selective accessibility.

Embodiments may enable the goals and objectives of existing commercial and personal data use cases to be fully satisfied when the comparison methods are applied to an entirely anonymous version of the underlying data. Embodiments may provide novel processes that are critical to the success of these enumerated goal and objectives such as guaranteeing compartmentalization of anonymous and non-anonymous data, including temporal, geographic and other anonymization barriers.

Embodiments may comprise components and processes that enable the disclosed systems to continually learn and improve the ability of those systems to perform cohort discovery, cohort-matching and cohort-matched content delivery in an entirely anonymous data space. Embodiments may comprise components and processes necessary to render a closed-loop system that continually updates a user's longitudinal data, such as that generated by financial instruments, wearable biometric devices, fitness equipment and household appliances. Embodiments may comprise the components, processes, and data utility metrics to anonymously incentivize and financially reward individual users based on a proportional value to business processes that exploit the anonymized data.

These and other features, and advantages, of the disclosed systems, methods, applications and devices are described in, or apparent from, the following detailed description of various exemplary embodiments.

### BRIEF DESCRIPTIONS OF THE DRAWINGS

Various exemplary embodiments of the disclosed systems and methods for providing platforms for anonymizing and storing the identifying data of individual users and groups of users, with computing device applications and services allowing varying levels of access and restrictions on access, according to this disclosure, will be described, in detail, with reference to the following drawings, in which:

FIG. 1 schematically illustrates a diagram of several classes of data, entities that generate or use the data, and a scheme of access patterns according to this disclosure;

FIG. 2 schematically illustrates an example of key system components for implementing data access according to this disclosure;

FIG. 3 illustrates an exemplary data flow diagram according to this disclosure;

FIG. 4A illustrates an embodiment of a system architecture for a plurality of Central Anonymized Servers according to this disclosure;

FIG. 4B illustrates an embodiment of a system architecture for a plurality of Central Account Servers according to this disclosure;

FIG. 5 illustrates an exemplary system architecture usable to implement one or more of an individual user's Private Data Server, or an individual user's Anonymized Data Server, according to this disclosure;

FIG. 6 illustrates a plurality of exemplary system architectures for embodiments of on-device components that may run resident on a user's personal devices;

FIG. 7 illustrates an exemplary network architecture of an embodiment of a user's private home network that comprises a local hardware device that may run both the Private Data Server and Anonymized Data Server components for the user;

FIG. 8 illustrates an exemplary system architecture of an embodiment of the local hardware device depicted in FIG. 7;

FIG. 9 illustrates an exemplary system architecture of an embodiment of Private Data Server and Anonymized Data Server components deployed on a cloud-computing platform within, for example, a virtualization framework;

FIG. 10 illustrates exemplary architecture and communication patterns of an embodiment of the Inverse Gateway Device;

FIG. 11 illustrates an exemplary software architecture of an embodiment including a Data Anonymization Module according to this disclosure;

FIG. 12 illustrates a plurality of exemplary communication patterns between a Private Data Server and an Anonymized Data Server as implemented by embodiments according to this disclosure;

FIG. 13 schematically illustrates exemplary architecture and communication patterns of an embodiment of a subsystem for automated collection of data from users' wearable devices, including smart watches;

FIG. 14 illustrates an exemplary lifecycle of an anonymous data model as implemented by embodiments according to this disclosure;

FIG. 15 illustrates an example of a structure and content for a process supporting generation of an anonymous data model according to this disclosure;

FIG. 16 illustrates an exemplary source listing and a diagram of a serialized data payload that may comprise a single instance of an anonymous data model;

FIG. 17 illustrates a high-level introduction to a process of an anonymous federated learning process according to this disclosure, including a plurality of mechanisms that address common points of failure for existing federated learning solutions;

FIG. 18 illustrates details a first stage of an anonymous federated learning process;

FIG. 19 illustrates details a second stage of an anonymous federated learning process;

FIG. 20 schematically illustrates an anonymous cohort-matched decision support process as enabled by this disclosure;

FIG. 21 illustrates a diagram of an exemplary cohort matching process;

FIG. 22 illustrates a diagram of an embodiment of a first stage of an anonymous, cohort-matched targeted advertising process, as implemented according to this disclosure;

FIG. 23 illustrates a diagram of an embodiment of second and third stages of an anonymous, cohort-matched targeted advertising process, as implemented according to this disclosure;

FIG. 24 illustrates a diagram of an embodiment of fourth and fifth stages of an anonymous, cohort-matched targeted advertising process, as implemented according to this disclosure;

FIG. 25 illustrates a diagram of an embodiment of a process of anonymously attributing an individual user's anonymized data as having contributed to building a global anonymous data model that has been constructed by a central system in the past;

FIG. 26 illustrates a diagram of an embodiment of a process of key generation executed in support of anonymous data utility determinations;

FIG. 27 illustrates a diagram of a software architecture and operation of an embodiment of a Compensation Module, by way of an illustrative example, including sub-components thereof and pseudocode listings for internal processes;

FIG. 28 illustrates an embodiment of a mechanism for encoding time series data anonymously;

FIG. 29 illustrates an algorithm used for anonymous cohort discovery according to this disclosure; and

FIG. 30 illustrates an embodiment of a process of anonymous cohort discovery according to this disclosure.

### DETAILED DESCRIPTION OF THE INVENTION

The disclosed systems and methods support advanced communication and data sharing by providing schemes for protecting users' private data as a user may choose to implement, while maintaining the data in a form, i.e., as anonymized data, that will still allow different entities to obtain certain useful information attributes regarding one or more users without access to such users' private data through implementing varying combinations of the features according to the disclosed embodiments.

The following definitions of terminology are provided for clarity aw used in this disclosure:
1. Server—
   a. a computer program (“software”) that provides functionality for other programs or devices, called “clients”, acting as one side of a client-server model. Servers can provide various functionalities, often called “services”, such as sharing data or resources among multiple clients, or performing computation for a client. A single server can serve multiple clients, and a single client can use multiple servers.
   b. Computer hardware that hosts and executes a server as defined in (a)
2. PHI— Protected Health Information, as defined by HIPAA.
3. Personal Identifiers (“PI”)— Data that can be used on its own, or in conjunction with any public data source, to identify an individual or entity.
4. Private data—Data that is descriptive of, identifies, or otherwise distinguishes an entity and that the same entity chooses not to reveal to another entity, including PHI and PI.
5. Anonymized data—Data that has been altered or truncated from its original form in order that it constitutes “Anonymous data”. The original form typically, but not necessarily constituting Private data.
6. Anonymous data—Data that cannot be used by itself, nor in conjunction with any public data source, to identify any individuals.
7. Entity—
   a. any user of the system.
   b. an individual person.
   c. an organized plurality of persons, e.g., a corporation.
8. Data model—
   a. a system of postulates, data, and inferences presented as a mathematical description of an entity or state of affairs.
   b. a computer simulation based on such a system.
   c. a serialized form of either a or b.
9. Cohort—a group of individuals having a statistical factor (such as age or class membership) in common.
10. Cluster—a set of objects or individuals that share one or more similar characteristics or attributes, where similarity is defined by some distance metric in the space of all common attributes. In the context of this specification, “cohort” and “cluster” are roughly synonymous since the invention is most interested in identifying clusters of people around a specified set of attributes or characteristics.
11. Centroid—a middle of a cluster; a vector that contains one number for each variable, where each number is the mean of a variable for the observations in that cluster; may be thought of as a multi-dimensional average of a cluster.
12. Vector centroid—synonym of “centroid”.
13. “Compromise of privacy”—An entity's privacy is considered “compromised” if any of the data the first entity considers private is both revealed to a second entity and attributable by the second entity to the first entity either alone or in conjunction with an additional publicly available data set.
“Revelation of Identity”
   a. An entity's identity is considered “revealed” if a second entity on the system can deduce or induce the precise identity of the first entity through attribution of personal identifiers to the first entity alone or in combination with an additional publicly available data set or by compromising the privacy of the first entity.

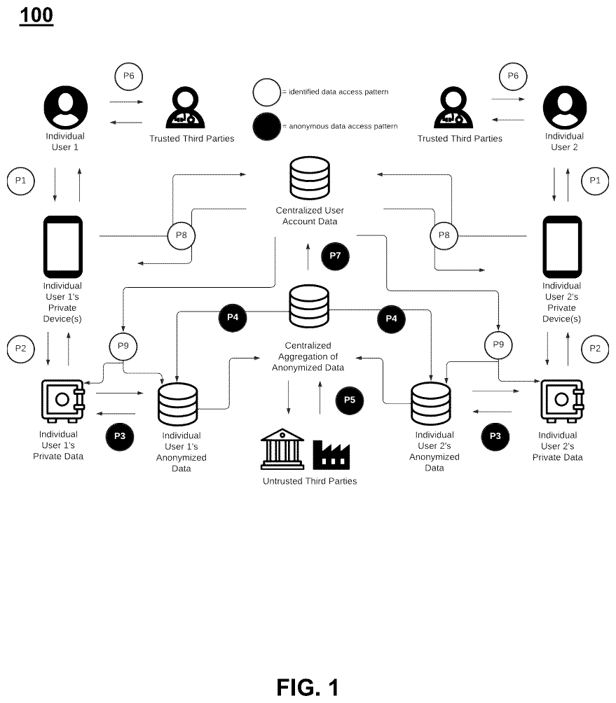

FIG. 1 schematically illustrates a diagram 100 of several classes of data, entities that generate or use the data, and a scheme of access patterns according to this disclosure. As shown in FIG. 1 high level data access patterns are provided that are supported by embodiments according to this disclosure. At a high level, embodiments distinguish between data that is anonymous and data that is not anonymous, and comprise components that effectively compartmentalize data storage and transmission to keep the two classes of data physically and logically separate at all times. The diagram 100 depicts the graphical separation of the two classes with black or white labels, respectively, to mark specific access patterns enabled by the disclosed embodiments. For example, access patterns P3, P4, P5 and P7 exclusively handle anonymous and/or anonymized data. All remaining patterns are not guaranteed to transmit anonymous data and therefore are labeled as belonging to an “identified” data space.

FIG. 1 will be used as a reference point within the remainder of the Detailed Description to contextualize specific system components. It should be noted that disclosed embodiments that enable the patterns in FIG. 1 may effectively compartmentalize and segregate anonymous and non-anonymous data, and the use-cases those data support. For example, in embodiments, untrusted third parties may be restricted to use cases supported only by anonymous or anonymized data (P5 in FIG. 1). Additional embodiments may restrict trusted third parties to use-cases that require a user's explicit permission to access any of the user's data (anonymous or private), and only by way of system components running, for example, on one of the user's personal devices such as a mobile phone (P6 in the figure). Embodiments may restrict all individual users to only indirect access to anonymized aggregates of data collected from other users of the system (P1 through P4 in FIG. 1).

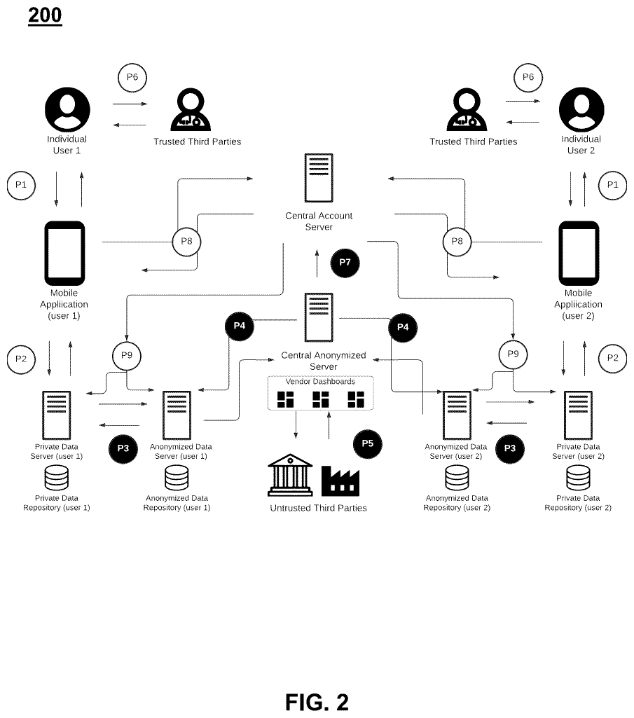

FIG. 2 schematically illustrates an example 200 of key system components for implementing data access according to this disclosure. Embodiments of the system and its components shown un FIG. 2, in the context of the data classes and access patterns, are substantially the same as depicted in FIG. 1.

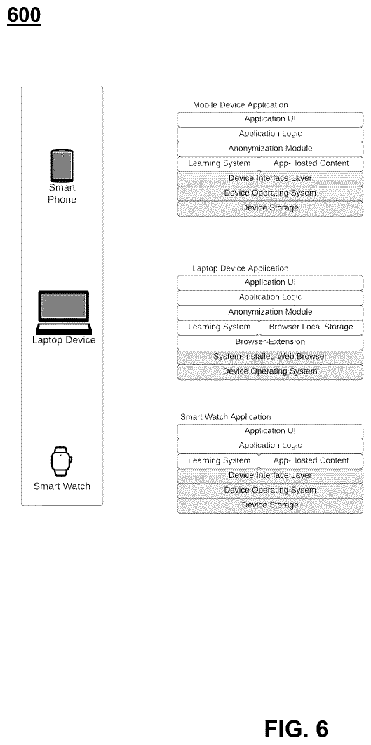

The depicted P1 access pattern may comprise interactions between individual users and their mobile devices (“personal devices”). Embodiments of the system may comprise a Mobile Application component installed on the user's personal device. Embodiments of the Mobile Application component may comprise software systems with an architecture such as that depicted in FIG. 6, and as will be discussed in greater detail below. Embodiments may enable user interaction with other personal devices, including, but not limited to users' laptops, tablets, fitness equipment, smart appliances, smart watches or other wearables. FIG. 6 details an architecture 600 of embodiments that may comprise a Laptop Device Application and/or a Smart Watch Application.

The P2 pattern in FIG. 1 may comprise all data transmitted between a user's personal device and a Private Data Server component that is dedicated to that user for personal use. The P3 pattern may comprise data transmitted between a user's Private Data Server component and the same user's Anonymized Data Server component.

In embodiments, individual users may be granted sole custodial rights on at least two data servers, each fulfilling a distinct purpose and hosting distinct classes of data. If a user's account on a larger system is, for example, in good standing, the user is effectively leasing the servers to host the user's personal data.

Embodiments may include a “Private Data Server” comprising computer hardware and software capable of storing, retrieving and encrypting an individual user's private data and identifying data.

Similarly, embodiments may include an “Anonymized Data Server” comprising computer hardware and software capable of storing, retrieving and encrypting an individual user's anonymized data.

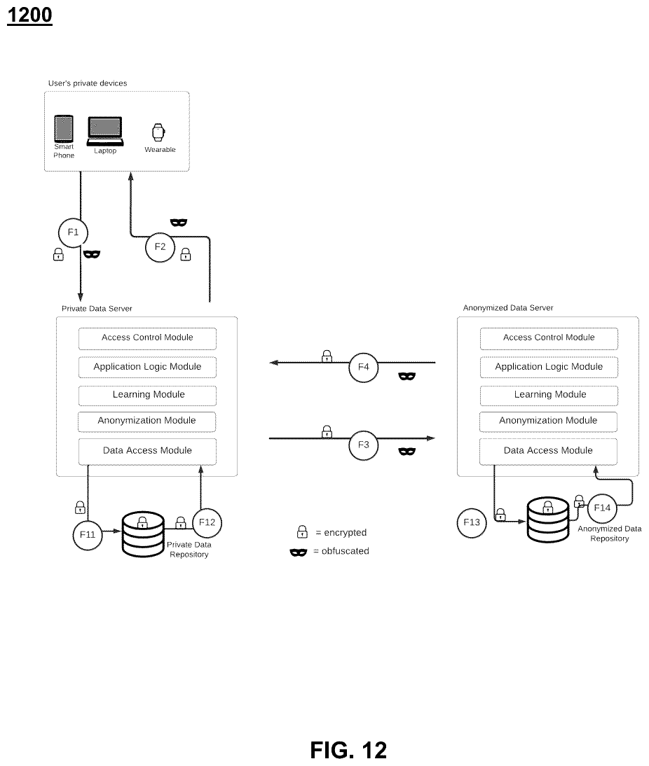

In embodiments, a communication pattern between the Private Data Server and the Anonymized Data Server may be restricted in any combination of the following ways:
1. The Private Server only sends anonymized data to the Anonymized Server;
2. The Private Server may not request any data from the Anonymized Server;
3. The Anonymized Server may not request any data from the Private Server;
4. The Anonymized Server may not initiate any communications with the Private Server; and
5. The Anonymized Server may not send any data of any kind to the Private Server; Communication between the Private Data Server and Anonymized Data Server is detailed further below in FIG. 12.

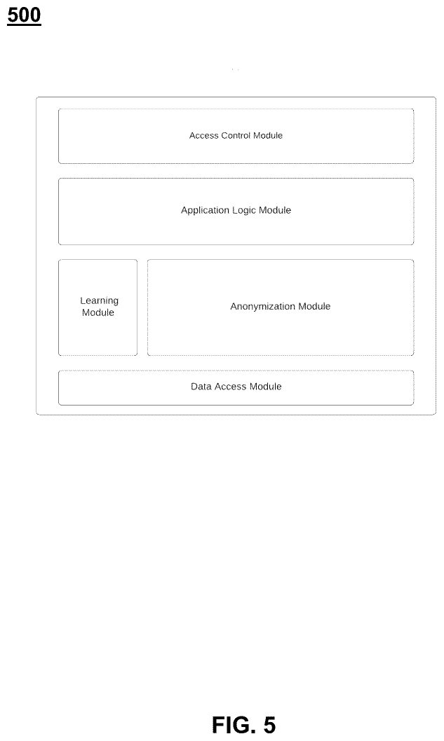

Embodiments of system architectures 500 of an individual user's Private Data Server, or an individual user's Anonymized Data Server is depicted in FIG. 5. In embodiments, the Private Data Server may enable functionality that may include:
a. storage of a user's private data locally on the Private Data Server;
b. storage of a user's private data on a plurality of external storage devices referred to collectively as the Private Data Repository component;
c. control of access to the user's private data;
d. anonymization of any subset of the user's private data;
e. transfer of any subset of the user's anonymized or anonymous data to the user's Anonymized Data Server component;
f. storage of a subset of the user's anonymized data locally on the Private Data Server;
g. storage of the user's anonymized data on a Private Data Repository component;
h. transfer of any of the user's private data to any of the user's private devices;
i. transfer of any of the user's anonymized data to any of the user's private devices;
j. transfer of a subset of anonymized data models to any of the user's private devices;
k. storage of media content to be served to the user; and
l. transfer of media content to any of the user's private devices.

The Anonymized Data Server may enable functionality that may include:
a. storage of the user's anonymous and anonymized data locally on the Anonymized Data Server;
b. storage of the user's anonymous and anonymized data on a plurality of external storage devices referred to collectively as the Anonymized Data Repository component;
c. controlling access to the user's anonymized data;
d. anonymization of any subset of the user's private data;
e. transfer of any subset of the user's anonymized or anonymous data to the user's Private Data Server component;
f. receiving anonymous data models from any of the Central Anonymized Servers;
g. execution of matching functions to compare the user's anonymized personal data against any of the anonymous data models received from any of the Central Anonymized Servers; and
h. functions as a “worker node” in a federated learning network comprised of all users' Anonymized Data Servers and all Central Anonymized Servers;

The P4 access pattern in FIG. 1 comprises all data transferred between any of the Central Anonymized Servers and any of the user Anonymized Data Servers.

Embodiments may include a Central Account Server that may be in a form of a centralized computer system comprising computer hardware and software capable of creating, storing and managing user accounts.

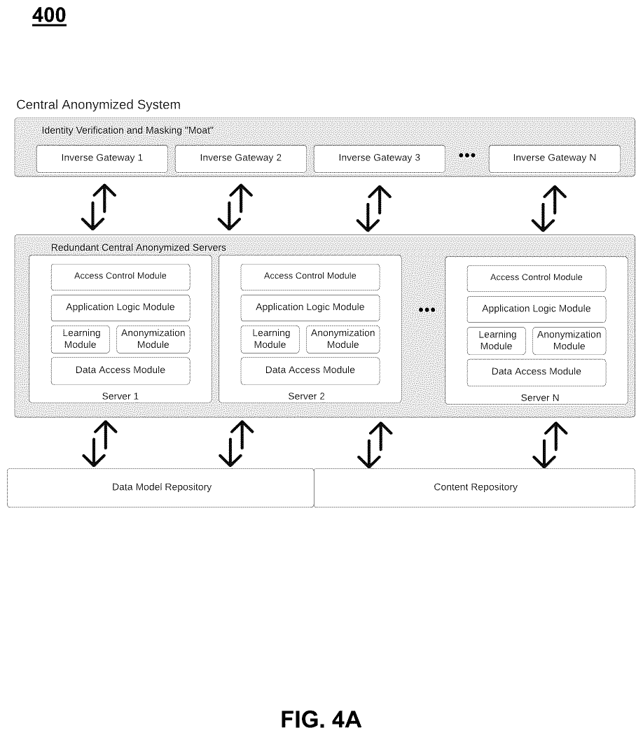

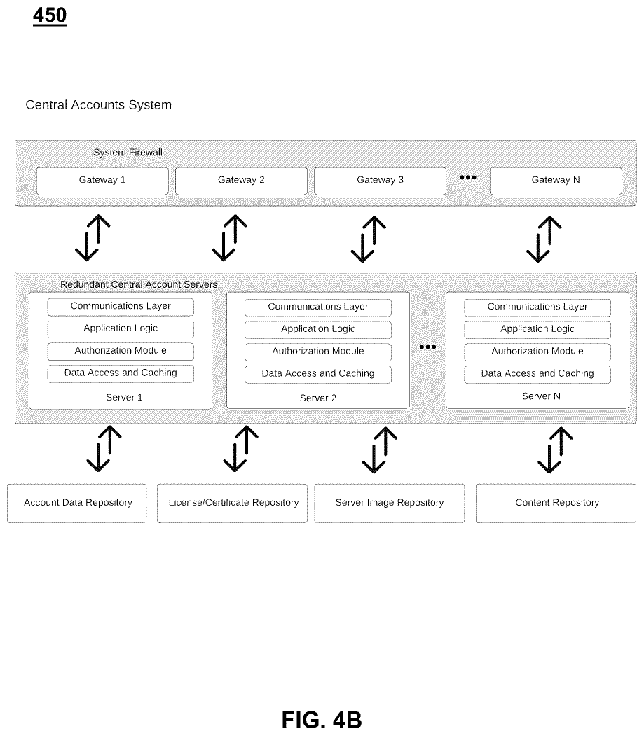

FIG. 4B illustrates an embodiment of a system architecture 400 for a plurality of Central Account Servers according to this disclosure. In embodiments, the Central Account Server may enable functionality that includes:
a. creation of new system accounts and credentials on behalf of users;
b. authentication of users of the system;
c. certification of new or updated data anonymization functions used by Anonymization Modules;
d. certification of new or updated data anonymization type definitions used by Anonymization modules;
e. certification of new or updated data privacy rules as may be enforced by the Data Policy Firewall of the Anonymization Module;
f. transfer of updated Private Data Server virtual system images to the cloud-based server infrastructure;
g. transfer of updated Private Data Server virtual system images to the hardware-based server infrastructure physically residing in users' homes;
h. transfer of updated Anonymized Data Server virtual system images to the cloud-based server infrastructure; and
i. transfer of updated Anonymized Data Server virtual system images to the hardware-based server infrastructure physically residing in, for example, users' homes.

Additional embodiments include a Central Anonymized Server that comprises computer hardware and software capable of creating, storing, querying, and broadcasting anonymous or previously anonymized data sets and models. FIG. 4A illustrates an embodiment of a system architecture 450 for a plurality of Central Anonymized Servers according to this disclosure. In embodiments, the Central Anonymized Server may enable functionality that includes:
a. acting as an orchestration server in a federated learning network comprising any Central Anonymized Servers and any users' personal Anonymized Data Servers;
b. executing anonymous cohort discovery processes;
c. updating and refining anonymous cohort data models;
d. executing cohort-matched content delivery processes;
e. executing cohort-matched targeted marketing processes;
f. executing cohort-matched decision support processes;
g. transferring any anonymous cohort models to any user's Anonymized Data Server;
h. receiving any anonymous cohort models from any user's Anonymized Data Server;
i. transferring any anonymous cohort models to any Central Account Server;
j. transferring any activity logs or usage statistics to any Central Account Server; and
k. transferring any global statistics about anonymous cohort models to any Central Account Server.

The P5 access pattern in FIG. 1 may comprise all data transferred between any Untrusted Third Party users of the system and the Central Anonymized Servers by way of the Vendor Dashboard component.

Embodiments may comprise a Vendor Dashboard Component which may be in a form of web applications. Web application embodiments may comprise a server component and a client component. The server component of the web application may comprise application server software. The client component of the web application may comprise a graphical user interface that is rendered and executed within a web browser on a client machine.

In embodiments, the Vendor Dashboard component may enable functionality that includes, for example, acting as the “user client device” interface to a Private Data Server instance that is dedicated to a single Vendor account and running as a virtual machine on a system's cloud hosted computing architecture.

Additional embodiments may comprise Anonymized Data Servers that are running as virtual machines in a cloud computing environment. In embodiments, these virtual Anonymized Data Servers may be dedicated to the virtual Private Data Server instances that have been assigned to a specific Vendor user.

The P7 access pattern in FIG. 1 comprises all data transferred from any Central Anonymized Server to a Central Account Server. In some embodiments, data may only flow in one direction along this connection, specifically from a Central Anonymized Server to a Central Account server, but not the reverse.

The P8 access pattern in FIG. 1 comprises all data transferred between any user's personal devices and any Central Account Servers

The P9 access pattern in FIG. 1 comprises all data transferred from a Central Account Server and any user's Private Data Server or Anonymized Data Server. In some embodiments, data may only flow in one direction along this connection, specifically from a Central Account Server to either a Private Data Server or an Anonymized server, but not the reverse. In embodiments, this connection may be used by the Central Account Server to send updated system software and/or operating system virtual images to be installed on either of the user's servers.

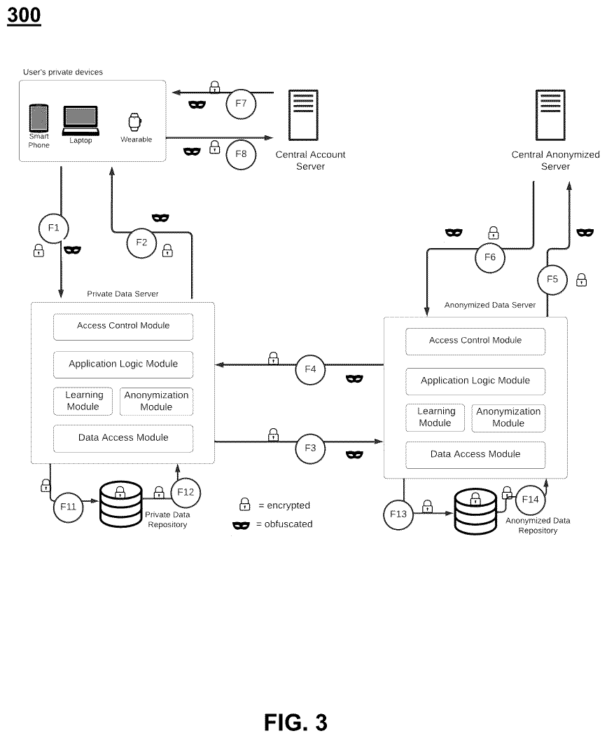

Several embodiments may apply encryption methods to a subset of data transmissions. Those, or other, embodiments may additionally apply obfuscation methods to a subset of data transmissions. FIG. 3 illustrates an exemplary data flow diagram 300 according to this disclosure. FIG. 3 depicts a subset of data flows as they exist in at least one embodiment. In the figure, data flows are marked as being potentially encrypted with a padlock icon and data flows are marked as being potentially obfuscated with a mask icon. In embodiments, all transmissions across a particular flow may be encrypted and obfuscated. For example, all data transmitted along flows F1, F2 in FIG. 3 may be both encrypted and obfuscated, and similarly data transmitted along flows F3 and F4 may be encrypted and obfuscated, and otherwise data transmitted along flows F5 and F6 are encrypted and obfuscated.

In embodiments, encryption schemes used for encrypting data transmissions may include a Secure Socket Layer or SSL encryption scheme. In embodiments, a subset of encrypted communications may use a fully homomorphic encryption scheme. In embodiments, obfuscation schemes used to obfuscate data transmissions may include a block cipher such as a Feistel cipher, or the Blowfish protocol. In embodiments, key sets used in the obfuscating block ciphers may be chosen at random and assigned to specific user account within the system. In embodiment, the block cipher key sets may be randomly generated multiple times per day per user account and at random intervals.

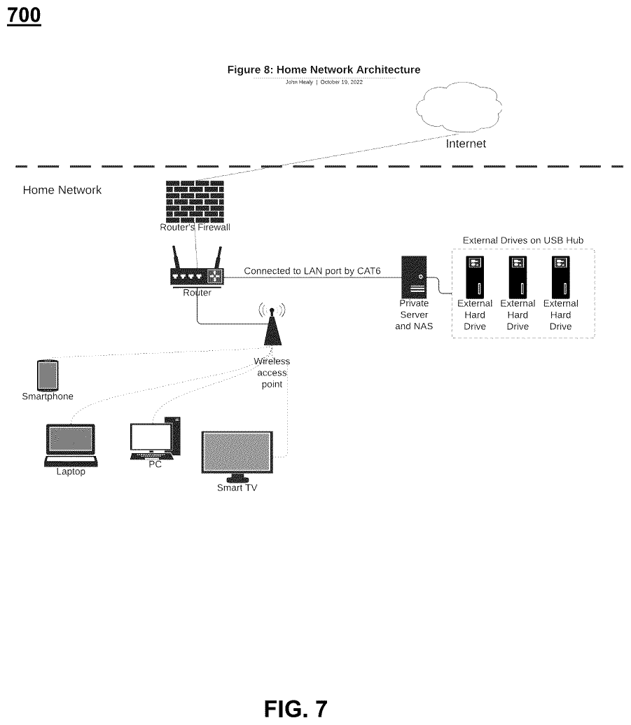

In embodiments, computer hardware that is running both the Private Data Server and Anonymized Data server may physically reside within the user's private home. FIG. 7 illustrates an exemplary network architecture 700 of an embodiment of a user's private home network that comprises a local hardware device that may run both the Private Data Server and Anonymized Data Server components for the user. In this regard, FIG. 7 details an embodiment of such a home network setup.

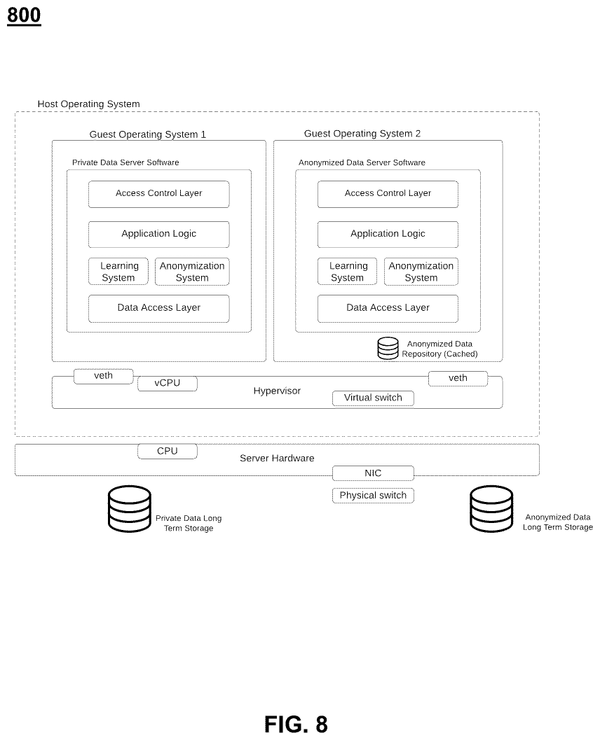

FIG. 8 illustrates an exemplary system architecture 800 of an embodiment of the local hardware device depicted in FIG. 7. FIG. 8 details an embodiment of the hardware and virtual server system architecture 800 that enables these embodiments of the Private Data Server and Anonymized Data Server. In the home network setup detailed in FIG. 7, computer hardware supplied to the user may reside behind the home network's firewall and may be physically connected to the user's router's Local Area Network (“LAN”) port using, for example, a CAT6 cable. In embodiments, the Private Server may present an additional interface to the local Wi-Fi network in the form of a Network Attached Storage (“NAS”) device. Such a configuration allows the user to supplement the storage capacity of the Private Server by connecting external hard drives to the server through, for example, a USB Hub.

In embodiments, the user's Private Data Server software and Anonymized Data Server software may both be running simultaneously on the local hardware as well as running redundantly in an off-site cloud-computing environment. In embodiments, the local Private Server may present the user with a graphical interface that allows the user to configure home devices to periodically copy data generated by those devices onto the Private Server. In embodiments, connected home devices may include fitness equipment, smart phones, smart televisions, personal computers, tablet devices, smart refrigerators, home security systems, climate control systems, smart thermostats, home energy monitoring and back-up systems, and the like. Embodiments may allow media content to be locally cached on the Private Server for faster playback on connected home devices.

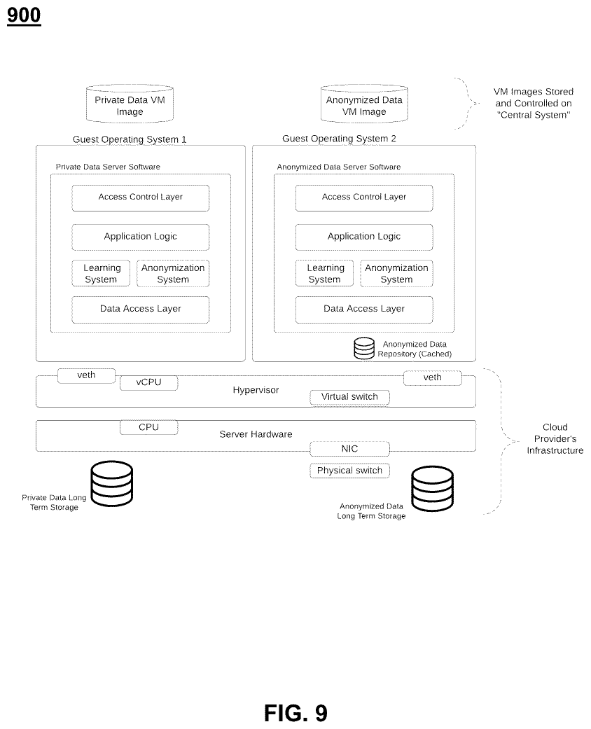

FIG. 9 illustrates an exemplary system architecture 900 of an embodiment of Private Data Server and Anonymized Data Server components deployed on a cloud-computing platform within, for example, a virtualization framework. In embodiments, users' Private Data Servers and Anonymized Data servers may be deployed on such a cloud computing architecture and running as virtual machines controlled by a hypervisor system.

In embodiments, users may be provided with two distinct servers: a Private Data Server (“private server”) and an Anonymized Data Server (“anonymized server”). FIG. 12 illustrates a plurality of exemplary communication patterns 1200 between a Private Data Server and an Anonymized Data Server as implemented by embodiments according to this disclosure. FIG. 12 depicts an exemplary flow diagram for data communications between the private server and the anonymized server, the private server and the private repository and the anonymized server and the anonymized repository.

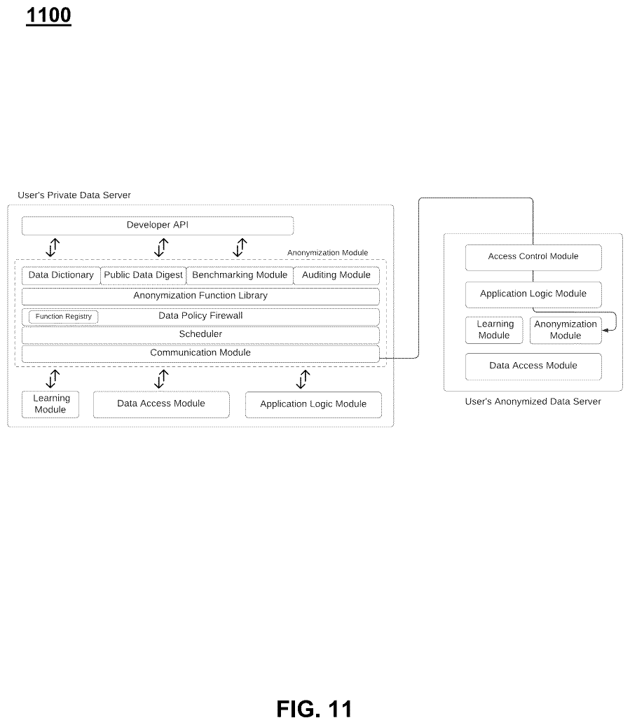

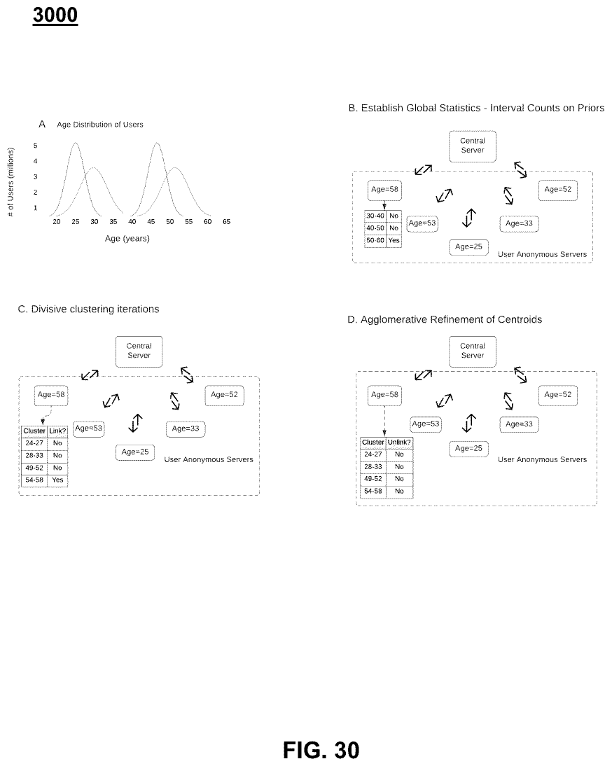

In embodiments, the private server may functions as the only source and the only sink for a user's private data. In other embodiments, the private server may include an Anonymization Module. FIG. 11 illustrates an exemplary software architecture 1100 of an embodiment including a Data Anonymization Module according to this disclosure. In embodiments, the data flow labeled F3 in FIG. 12 may be restricted to pushing only anonymized data from the Anonymization Module. In other embodiments, all data originating from any user device may only be stored on that user's private server. Such an embodiment is depicted in flows F1 and F2 in FIG. 12. Additional embodiments comprise an anonymized server capable of pushing/sending anonymized data back to the corresponding user's private server, including:
a. anonymous cohort centroids (or “models”) with attached Learning Identifier (see FIG. 30 described in greater detail below)
b. anonymized embodiments of the user's private data
c. anonymous amendments to a. or b.;
d. anonymous attachments to a. or b.;
e. anonymous annotations of a. or b.; and
f. new or updated data privacy rules that may originate from the Central Anonymized Servers.
   Embodiments sending payloads (a) through (f) above may use data flow F4 in FIG. 12. In other embodiments, all data payloads transmitted from the user's anonymized server may originate from the Anonymization Module component of the user's anonymized server, enabling all outgoing data payloads to be tested and verified as being anonymous according to latest data privacy constraints, as may be encoded and applied by the Data Policy Firewall component of the Anonymization Module (see FIG. 11). In embodiments, all system-wide components comprise identical Anonymization Module components, including:
a. All users' Private Data Servers;
b. All users' Anonymized Data Servers;
c. All Central Anonymized Servers;
d. All Central Account Servers; and/or
e. All users' Mobile Application components.
   In these embodiments, system-wide instances of the Anonymization Module may further comprise identical global data privacy rules, which may be synchronized by the Central Anonymization Servers and propagated through the network of all users' Anonymized Data Servers.

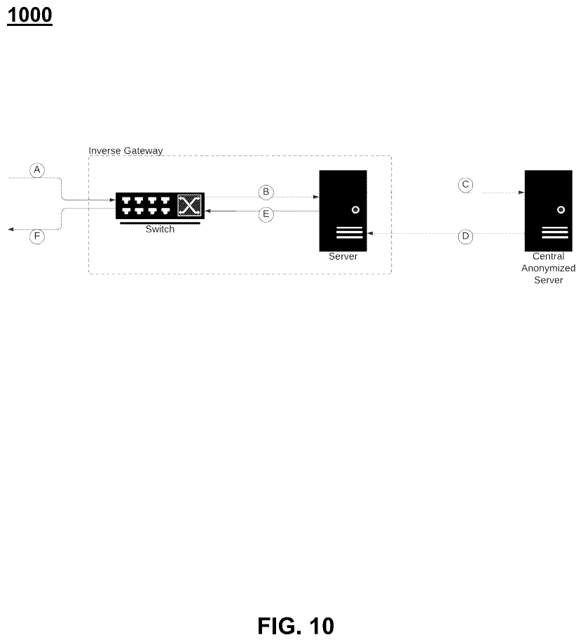

FIG. 10 illustrates exemplary architecture and communication patterns 1000 of an embodiment of the Inverse Gateway Device. Embodiments may comprise such an Inverse Gateway Device. The choice of nomenclature for the “Inverse” gateway device stems from its unconventional IP-masking behavior. Typically, network switches and gateways at a computer network's boundary use IP-masking to make all network traffic exiting the network appear as though it is originating from a single IP address, usually one that is assigned to the switch itself. In embodiments, the Inverse Gateway device may invert that behavior. In these embodiments, the Inverse Gateway masks all incoming IP addresses to make all incoming traffic appear as though it is originating from that specific Gateway. In embodiments, the Inverse Gateway may comprise at least one network gateway device. The network gateway device may be configured to perform IP-masking on all inbound network traffic such that a source IP address in IP data packet headers may be replaced with an IP address of the network gateway device itself.

It is worth noting that the source IP address attributed to incoming connection requests from any user device may often be used to identify a geographic location of the device making the request. This geographic location can be precise enough to identify an individual that—for example, resides at that location. Even in cases where a device location is less precise, it is frequently precise enough to narrow a list of potentials sufficiently that it would be comparatively simple to identify an individual when combined with an otherwise anonymized data model that tagged along in the request content. For this reason, embodiments, may provide the IP masking capability of the Inverse Gateway device to achieves greater geographic anonymization of all incoming requests to the Central Anonymized Servers.

In embodiments, the Inverse Gateway Device may further comprise a computer server device, or “gateway server,” as shown in exemplary form in the example provided in FIG. 10. In embodiments, the Central Account Server may send updated mappings of validated and current client IP addresses and their corresponding account numbers. Along with this mapping, the Central Account Server may also send, for example, at least a pair of globally unique 2048-bit tokens. In embodiments, one such token may be one of two keys in an asymmetric encryption key pair, where the second key in the encryption pair may have been previously sent to the client devices that correspond to the current account holder. In other embodiments, a copy of the second token may also have been sent to all client devices corresponding to the current account holder. In embodiments, the Central Account Server may generate multiple token sets per valid user account per day and sends them to all corresponding client devices and all gateway servers. In other embodiments, the Central Account Server may generate multiple token sets at random intervals throughout each day.

In FIG. 10, the labeled data flows may correspond to one or more of the following data payloads and possible modifications applied at each touch point:
a. encrypted and obfuscated request payloads originating from any user's Anonymized Data Server;
b. same as a., but with source IP mask values added to look like the data originated at Switch;
c. same as b., but with client account validation successfully performed by Server and potentially having “success” flags added to payloads, source IP masked;
d. Encrypted and obfuscated response payloads intended for Anonymized Data Server belonging to validated account holder;
e. Same as d., but with the destination IP returned to its original unmasked value; and
f. Same as e., but with source IP masked to look like the payload is originating from the Switch.

Embodiments may comprise an Anonymization Module as shown in FIG. 11. In embodiments, a Scheduler component may act as both a work queue and an execution framework within which data anonymization processes are performed. In embodiments, the Scheduler may invoke data anonymization functions that are defined and stored in an Anonymization Function Library. In embodiments, there may be a Data Policy Firewall that may strictly enforce global and user-defined or user-selected data privacy policies. In embodiments, the Data Policy Firewall may block the execution of certain data transfers and data anonymization functions. For example, if a user selects an option that disallows any transfer of MRI image data off their Private Data Repository, then any functions invoked by the Scheduler may likely fail to execute, returning an error code, such as, for example, a “Data Policy Violation” error code to the Scheduler.

Embodiments of the Anonymization Module may comprise a Communication Module that may package and validate all anonymized data payloads prior to being sent to the user's Anonymized Data Server. In some embodiments, the user's Anonymized Data Server may also comprise an Anonymization Module. In other embodiments, the Central Anonymized Server also comprises an Anonymization Module. In some embodiments, anonymized data payloads sent from the Communication Module on the user's Private Data Server may be received on the same user's Anonymized Data Server's Anonymization Module's Communication Module, as depicted, for example, in FIG. 11.

In embodiments, the only method by which a user's Private Data Server may send data payloads to the same user's Anonymized Server may be through the Communication Module in the Anonymization Module on the Private Data Server. In embodiments, the Data Policy Firewall may have a default policy that blocks any and all communication of data payloads off of the Private Data Server, particularly those that have not: a. been anonymized by a pre-validated anonymization function; and/or b. passed all anonymization tests enforced by the Data Policy Firewall.

In embodiments, the Data Policy Firewall (“Firewall”) may comprise a Function Registry. The Function Registry may acts as a local certification authority for all data anonymization functions available in the Anonymization Function Library (“Library”). In embodiments, in order for a new function to be successfully added to the Library, the new function must have a currently valid certificate in the Function Registry. In embodiments, a valid certificate may be issued by the Central Account Server only after the function has passed benchmark testing and been subjected to human code review. In embodiments, the Firewall may comprise rules that may block execution of any function that does not have a currently valid certificate in the Function Registry.

In embodiments, functions that are stored in the Library may execute tests that are intended to ensure that a data anonymization operation was performed properly. Embodiments of the Anonymization Module may comprise a Data Dictionary. The Data Dictionary (“Dictionary”) may comprise globally recognized data type definitions that are both human readable and can be used as classes to be instantiated by functions in the Library. In embodiments, the Dictionary may also comprise a data type mapping of data type homonyms, synonyms and encoding variants.

Several embodiments of the Anonymization Module may be extensible in that they may comprise application programming interfaces (“API”). A particular API may enable software developers to code, test and deploy novel anonymization functions. The API may comprise its own data types and functions. The data types and functions may be used by developers to extend or alter the behavior of a subset of functions in the Library, and to add entirely new functions to the Library. In embodiments, types of functions that are permitted to be added to the Library by the Firewall may include data anonymization functions and anonymization validation tests. In embodiments, the API may comprise data classes and functions that enable developers to add new definitions, homonyms, or synonyms to the Dictionary. This allows the disclosed embodiments to avoid confounding data concept drift or data concept shifts over time.

In embodiments, the API may comprise classes and functions that enable developers to add new policies to the Firewall. Some embodiments may restrict the API to accessing or otherwise altering the content or behavior of the users' Private Data Servers based on the Central server of origin and the level of certification granted by that server. For example, in some embodiments, new functions developed by third parties that have been certified by and propagated from the Central Account Server may be restricted to accessing, or otherwise modifying, only users' Private Data Servers and/or users' Mobile Application components. In embodiments, only functions that have been certified and propagated by the Central Anonymized Servers may access or otherwise modify any user's Anonymized Data Server.

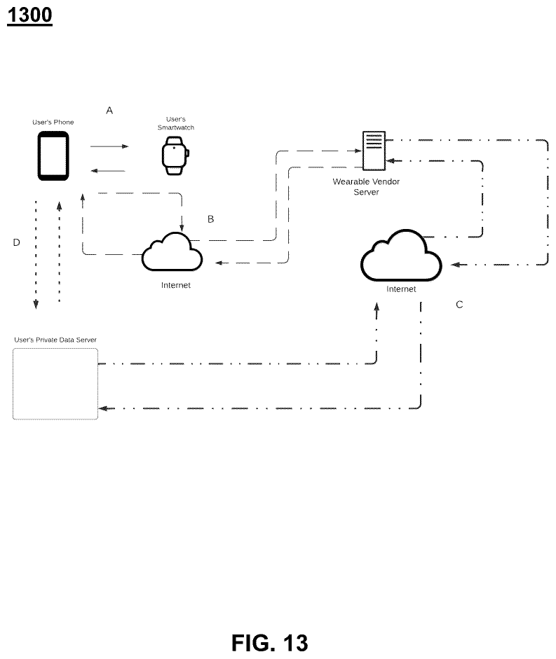

Embodiments may enable users to passively collect data from users' wearable devices or smart watches with their personal Private Data Server. FIG. 13 schematically illustrates exemplary architecture and communication patterns 1300 of an embodiment of a subsystem for automated collection of data from users' wearable devices, including smart watches. FIG. 13 details the data flows. Flow A depicts a connection between the user's mobile device (“phone”) and the user's wearable device (“wearable”), which many wearable vendors accomplish using the Bluetooth protocol. Flow B depicts a connection between the wearable and the wearable vendor's servers. Typically, wearable vendors require a mobile application to be installed on the user's phone and the wearable device may connect to the vendor's servers indirectly through the companion mobile application over any available internet connection. Flow C depicts a connection between the user's Private Data Server and the wearable vendor's server. Flow D depicts a connection between the user's Private Data Server and the user device application component of an exemplary embodiment, which may be running as a mobile application on the user's phone. In embodiments, the user may grant the system's mobile application access to the phone's local application data storage. Typical wearable device applications store a subset of the user's wearable data in the phone's local application data storage. In embodiments, the system's mobile application may automatically and repeatedly send a copy of the wearable data to the user's Private Data Server over connection Flow D. Typical wearable device implementations store more detailed longitudinal data on the vendor's servers (rather than on the user's phone). Furthermore, these same vendors typically present their customers with a web-based graphical interface (“web app”). These vendor web apps allow users to log in to an account on the vendor's servers where the user's more detailed wearable data is stored. Typically, these web apps also allow the user to explicitly download the more detailed longitudinal data by selecting a menu item in the web app.

Disclosed embodiments may allow users to store their wearable vendor account credentials on their Private Data Server. In embodiments, the Private Server may use those account credentials through, for example, a headless web browser that may automatically and repeatedly log in to the user's account on the wearable vendor's server and select an appropriate sequence of menu items in order to download the user's detailed wearable data from the vendor and store it locally on the user's Private Data Server. In embodiments, the Central Account Server may allow users to create, for example, email accounts that are hosted by the Central Account Server. This may allow the user to then alter the user's contact information associated with the user's wearable vendor account. This, in turn, may allow the disclosed embodiments to automatically complete certain multi-factor authentication processes that may be necessary to gain access to the user's detailed wearable data on the vendor's server.

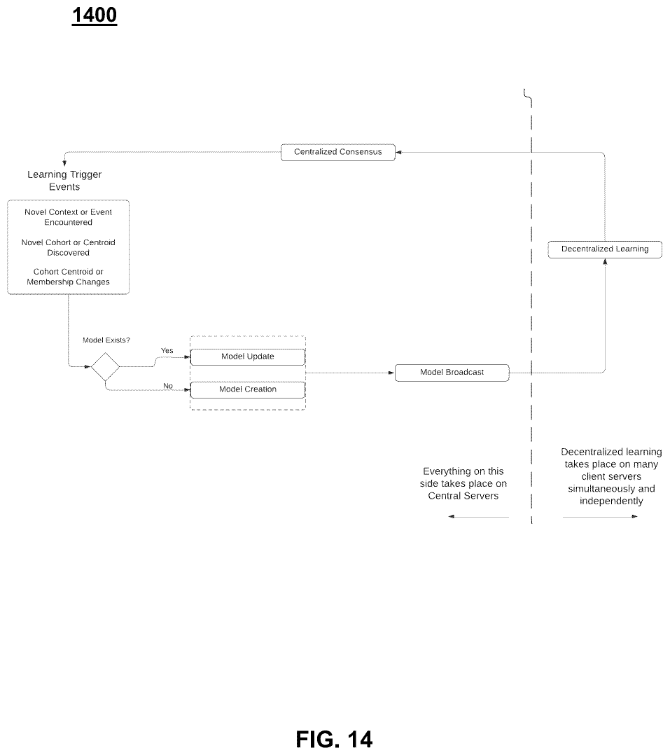

FIG. 14 illustrates an exemplary lifecycle 1400 of an anonymous data model as implemented by embodiments according to this disclosure. As shown in FIG. 14, the life cycle of a model may begin with a trigger event. Examples of trigger events include:
a. novel contexts or events that occur in the central system;
b. novel cohorts or cluster centroids discovered within the central anonymous data set;
c. changes to cohort membership or drift in the centroid of a cohort or cluster;
   In a case in which the model affected by the trigger event already exists in the system, the model may be updated and broadcast out to the decentralized network. In the case that the change results in the need for a new model entirely, such a new model may be created to represent the trigger event then broadcast out to the decentralized network.

Regardless of a learning scenario, a stage that may come after broadcasting of a model to the decentralized network may be private learning that takes place at each node in the decentralized network of private servers. As each private server completes its internal learning process, each private server may then send back the privately educated model to the central server to support, or implement, a consensus learning process. The consensus learning process for any given model may be ongoing, allowing for the asynchronous arrival and addition of the next privately educated model copy. In this manner, a federated learning process may be implemented and executed.

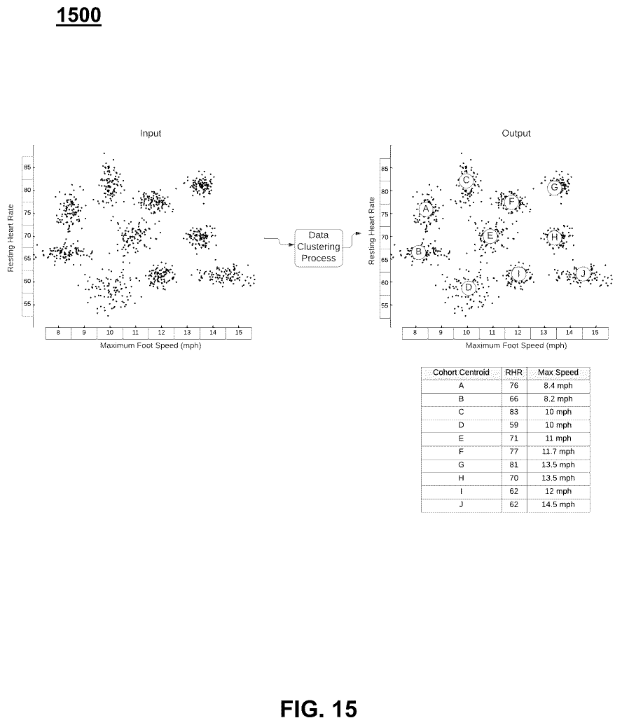

In embodiments, data models (“models”) may represent a centroid of a cluster of users that may share certain attributes in common. FIG. 15 illustrates an example of a structure 1500 and content for a process supporting generation of an anonymous data model according to this disclosure. FIG. 15 specifically depicts an example of a cluster analysis process that may result in definition of several such centroids. Each centroid may be considered to represent a group, or cluster of people that have similar values for two specific attributes. In this example, the two specific attributes are resting heart rate (“RHR”) and maximum foot speed (“max speed”). Each centroid may be defined by the average value of that attribute for its respective cluster. For instance, centroid J in FIG. 15 represents a group of people with an average resting heart rate of 62 beats per minute and an average maximum foot speed of 14.5 miles per hour.

In embodiments, data models may comprise a neural network that has been trained to classify individuals as belonging to one or more of a set of predefined cohorts.

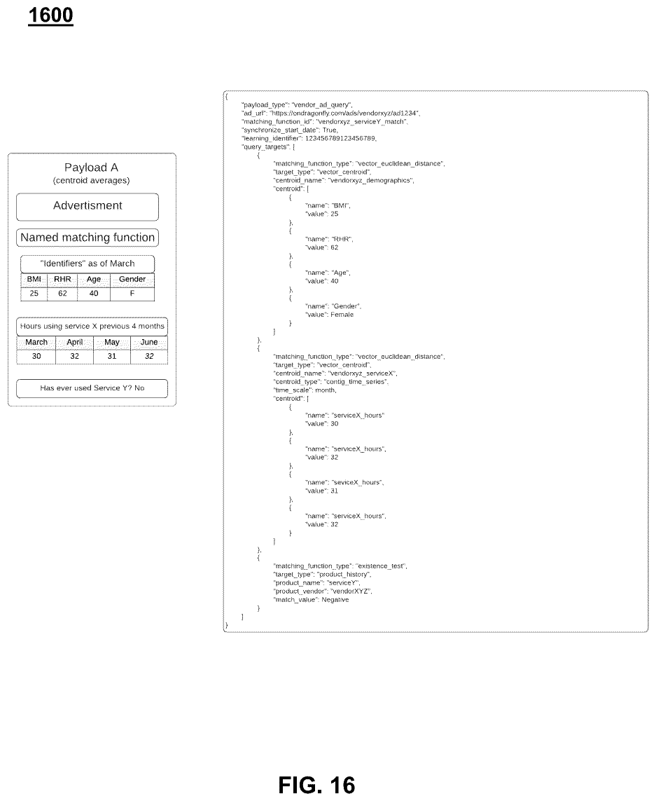

In embodiments, data models may be communicated between physical and/or virtual devices on the network as payloads encoded in a computer-readable format. FIG. 16 illustrates a depiction 1600 of an exemplary source listing and a diagram of a serialized data payload that may comprise a single instance of an anonymous data model. Some data model payloads may be encoded in JSON format. In embodiments, data models may be serialized in binary formats such as HDFS or ONNX. Some embodiments may use the ONNX format for the serialization of neural network activation weights. Embodiments may serialize neural network models in a hybrid format comprising both binary content, such as ONNX as well as computer/human-readable content, such as JSON.

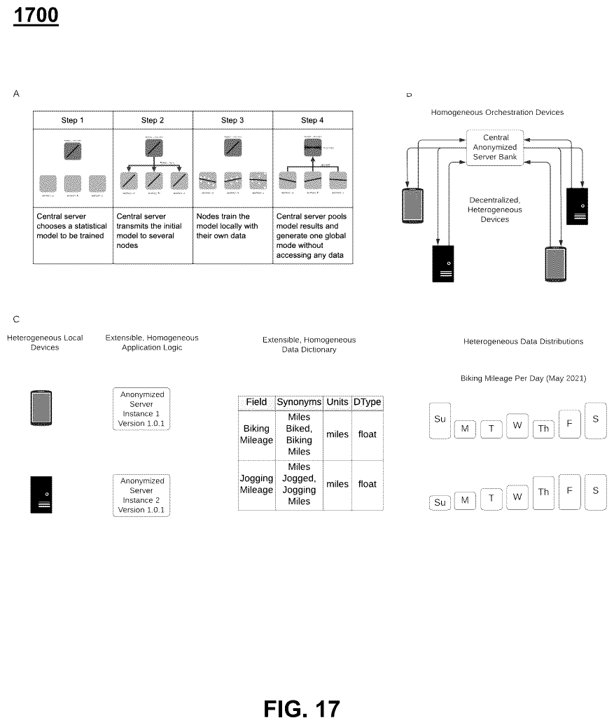

FIG. 17 illustrates a high-level introduction 1700 to a process of an anonymous federated learning process according to this disclosure, including a plurality of mechanisms that address common points of failure for existing federated learning solutions. Disclosed embodiments may comprise such a system capable of federated learning, including further comprising a machine learning approach that trains an algorithm or learns a global data model across multiple decentralized edge devices or servers holding local data samples, without exchanging those local data samples.

Some embodiments may comprise a plurality of centralized servers that may act as orchestration devices for the federated learning process. These orchestration servers may be substantially the same as the Central Anonymized Data Servers depicted elsewhere including the redundant servers in FIG. 4A.

In certain real-world scenarios, the assumption of independent and identically distributed samples across local nodes may not hold for federated learning setups. To address this challenge, disclosed embodiments may comprise an application logic module that is homogeneous across all client devices, despite the heterogeneity of the client hardware itself. This application logic module is as depicted in FIG. 3, while its role in federated learning may be as detailed in FIG. 17.

Some embodiments may comprise an additional data dictionary which may also be homogeneous across some or all client devices. The data dictionary, and its role in federated learning, may be as detailed in FIG. 17. The data dictionary, while explicitly constructed as a sub-component of the Data Access Module, may also be accessible to the Learning, Anonymization and Application Logic Modules of the Anonymized data server.

As depicted in FIG. 17, disclosed embodiments expect, and accommodate, heterogeneity of data distributions across individual client devices. This heterogeneity may typically manifest as differences in a quantity and temporal distribution of data points of any specific data type. For example, as illustrated in FIG. 17, it is possible for there to be zero or more data points of a given type among clients (jogging miles per day in the example). Further, it is possible for measurements of a specific type to vary in the temporal units (time of day, days per week, etc.) and/or continuity (gaps on Wednesday in the biking example). The disclosed embodiments may comprise data structures that can store, retrieve, and compare such heterogeneous data sets due to the homogeneity of data definitions in the common data dictionary. Embodiments may further comprise an API that allows external software developers to extend the data dictionary to include new data types, features or labels.

Several embodiments of the current invention comprise a Learning Module that is incorporated in every instance of the Anonymized Data Server software across client devices.

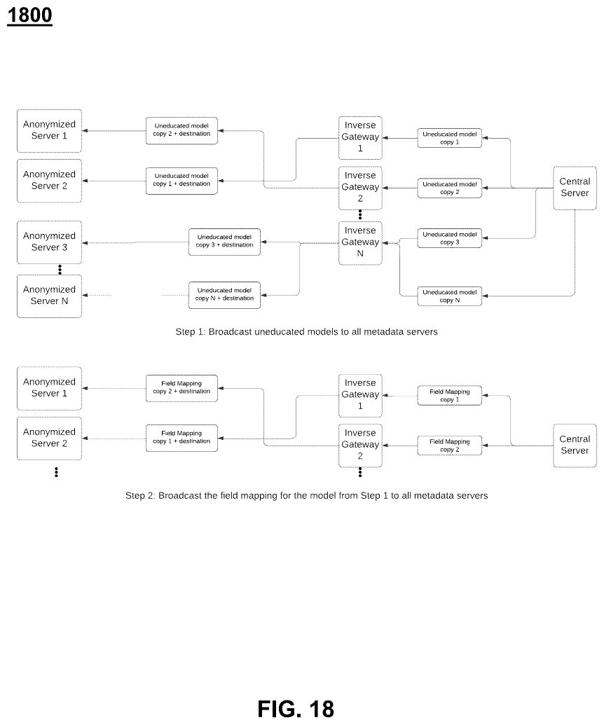

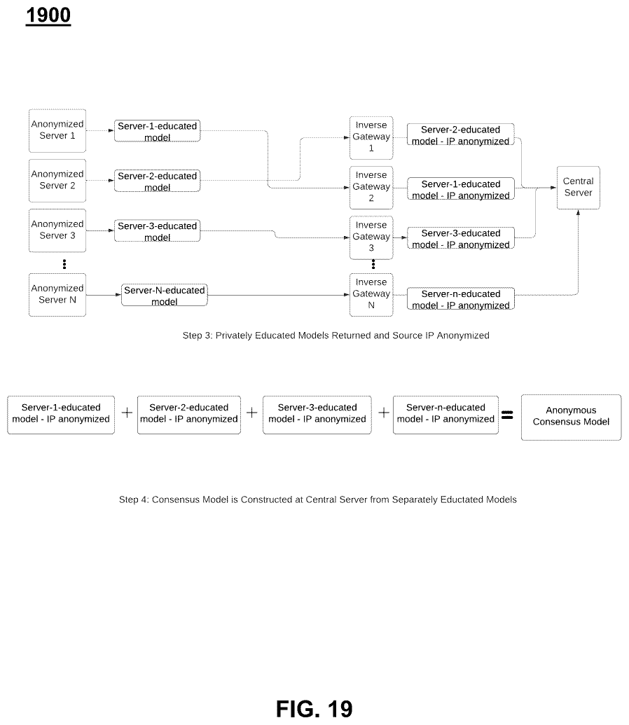

For the federated learning process to take place, the invention must provide mechanisms for anonymous data models to be communicated from the Central Anonymized Servers (“orchestration server”) to the users' Anonymized servers (the “worker nodes”) and back again. Embodiment of this communication mechanism may be as detailed in FIGS. 18 and 19.

FIG. 18 illustrates details a first stage 1800 of an anonymous federated learning process. FIG. 18 specifically diagrams the first stage of the communication process as implemented by several embodiments. In these embodiments, the Central Anonymized Servers acting as an orchestration server (“server”) may, as Step 1 in the process, first broadcast uneducated (or “untrained”) models out to a subset of the users' Anonymized Data Servers acting as the worker nodes (“workers”) in a federated learning network. The server may then, as a Step 2, broadcast out the field mappings that should be applied to the data models sent in the previous Step 1. The field mappings may act as a dynamic data dictionary applied locally by the workers as a map of how to interpret and to select local data fields to build input vectors for the local training process.

FIG. 19 illustrates details a second stage 1900 of an anonymous federated learning process. FIG. 19 diagrams the next two steps of the federated learning process, as implemented by embodiments. Step 3 specifies a return trip of the data models that have been locally educated or “trained” at each Anonymized Server to the bank of Inverse Gateway devices where the data payloads have their source IP addresses anonymized (as detailed in specification of the Inverse Gateway device above and in FIG. 10). The IP-anonymized payloads may then be forwarded to the Central Server for the consensus step, which is shown in Step 4 in FIG. 19. In embodiments, the consensus learning step may comprise summing of counts associated with a cohort model or cluster centroid. In embodiments, the consensus learning step may comprise a merging of neural networks that have all been trained local to each worker node.

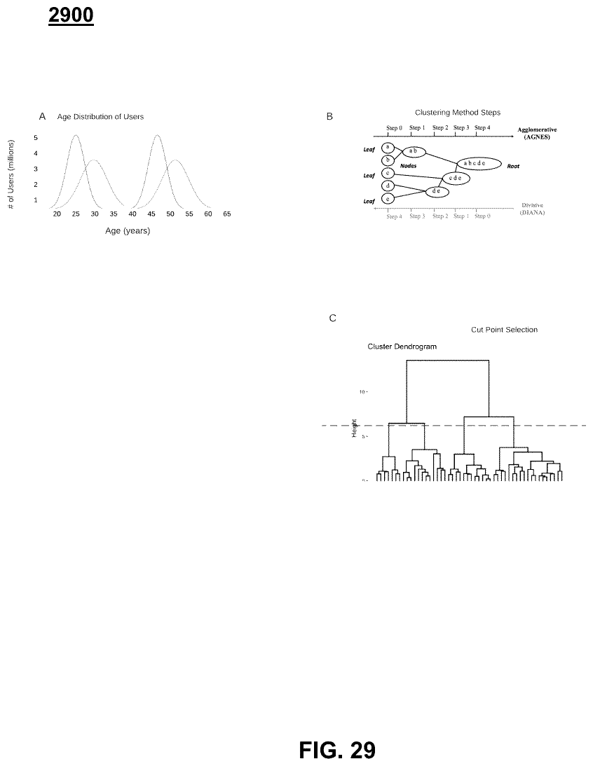

Embodiments may enable a semi-automated process of anonymous cohort discovery. FIG. 29 illustrates an algorithm 2900 used for anonymous cohort discovery according to this disclosure. FIG. 29 depicts cohort discovery by application of a clustering algorithm. FIG. 29 (at “A”) depicts an example age distribution for users of the system with cohorts deconvolved to clearly display ideal centroid choices (e.g., ages 25, 32, 47, 52). This ideal deconvolution may not be known to the system prior to cohort discovery. A single dimension (here, a user's age) was chosen for simplicity of illustration. The system also does not typically have an expected number of centroids prior to a clustering process. Agglomerative clustering algorithms, such as AGNES, are commonly used to cluster data where no prior expectation of the number of clusters exists. However, agglomerative clustering begins with the assumption that every data point belongs to its own cluster and then iteratively attempts to merge points together based on some similarity metric. This first step would necessitate the sending of explicit values, ages in this example, from individual user's servers directly to the central server. While age alone cannot typically identify an individual, the invention attempts to generalize to higher dimensional vectors of attributes, or composites such as defined by the tuple ([Age, Gender, Height, Weight], [Last 4 months of heart rate measurements]). The system may then generally assume that individual user data vectors could become arbitrarily specific. For this reason, the exemplary embodiment depicted in FIG. 29 (at “B”) may implement divisive clustering, which is understood to be substantially an inverse of agglomerative clustering. Specifically, its initial assumption may be that every data point belongs to a same cluster. The process then may iteratively divide clusters based on measures of heterogeneity within each cluster. This may yield a progression that begins at maximal anonymity for the users and iteratively becomes less anonymous (or more specific). Therefore, embodiments that use such divisive clustering may have two stopping criteria for any clustering iteration, such as, for example, a. no further change in internal heterogeneity of a cluster, and b. further clustering being deemed to render the cohort too specific (e.g., too few members of a high-dimensional cluster). Stopping criterion (b) may be included to attempt to ensure that once centroids are defined and subsequently encoded as data models by the Learning Module, their propagation across the larger network of user servers minimizes risk of user identification in general. Further, the specific choice of stopping criteria for a particular cluster may be specified to attempt to ensure that members of the cluster cannot be identified. FIG. 29 (at “C”) depicts an exemplary internal negotiation process that may be undertaken to, for example, determine where to establish height cut points in the hierarchical clustering dendrogram that is a byproduct of the divisive (or its inverse agglomerative) clustering process.

FIG. 30 illustrates an embodiment of a process 3000 of anonymous cohort discovery according to this disclosure. FIG. 30 (at “A”) reprints the exemplary age distribution shown in FIG. 29 (at “A”) for clarity. FIG. 30 (at “B”) depicts the first stage of the cohort discovery process as implemented by several embodiments. In this first stage, the Central Anonymized Server may determine the extremities (max and min), and any potentially large biases, in an underlying user population. In doing so, the process may first check the Public Data Digest of its Anonymization Module (see FIG. 10) for any relevant, publicly accessible data sets that can be used as an informative prior for estimating an initial set of cluster boundaries. For example, the age distribution of people in the United States is published by the Census Bureau. This publicly-available data may provide the Central System an initial expectation of how many users may belong to any specified age group or interval. Such information can serve at least three purposes:
a. it can allow the process to “guess” the initial cluster boundaries based on the priors and the estimated likelihood of preserved anonymity of users;
b. it can use this prior as a comparator in estimating user population bias (versus a random sampling of the general population); and
c. it can make the clustering process more efficient by saving iterations of cluster division.

FIG. 30 (at “B”) also depicts a “private learning” process that takes place in embodiments of a user's personal Anonymous Server. This process is referred to as “private learning” since the user's exact data values are privately compared against an anonymous model, and an annotated version of the model that preserves the user's anonymity is returned to the Central Server for the “consensus” learning phase. In embodiments, the anonymous model sent to the user's server may be as simple as a set of intervals (age intervals in the example of FIG. 30). Each interval is chosen to be inclusive enough so as to render the knowledge of a person's membership in that group useless for the purpose of identifying that person. For example, knowing that a person from the United States belongs to the age group 50 to 54 years old “narrows” the search space to roughly 20 million people as of 2020 or roughly 6% of the population. In embodiments, the “consensus learning” phase of cohort discovery is a simple summation of interval or model match counts as they are received asynchronously from the user servers. In embodiments, the model being passed back and forth with the user servers may be a neural network. In those embodiments, the consensus learning phase may comprise an averaging of weights in the corresponding layers of otherwise identical networks that have been trained privately on the separate user servers.

FIG. 30 (at “C”) depicts all the iterations of the divisive clustering process as implemented in embodiments. The double arrows between user servers and the Central Server signify successive rounds of back-and-forth communication of revised candidate cluster boundaries (all satisfying the Central Server's anonymity criteria). The table shown below one of the user servers depicts a single round of private learning executed on that server. In the case of the divisive clustering iterations, the private learning process comprises a check to see to what extent an exact value corresponding to the user, age 58 years in the example, satisfies the linkage criteria used for estimating the gain/loss of cluster heterogeneity. In an embodiment this can be as simple as incrementing a count in an interval that includes that user's age or checking for membership of that age within the interval as shown in the figure.

FIG. 30 (at “D”) depicts an optional final step of the anonymous cohort discovery process as implemented by an embodiment. In this step, the Central Server may invert the clustering process to an agglomerative phase, but only for a subset of clusters that are not in danger of compromising a user's anonymity. The included table depicts this private learning step for only one of the user servers.

Embodiments may enable vendors to run highly targeted marketing campaigns among the users without ever having access to data that could identify a user, or to any user private data.

An embodiment of this process may include at least 5 stages:
1. Select target audiences anonymously;
2. Package up advertising payloads for each anonymous target audience;
3. Broadcast all payloads to all users;
4. Perform a cohort-matching operation on every client's Anonymized Data Server;
5. On condition of a cohort match, push an advertisement to a user client device for display to the user.

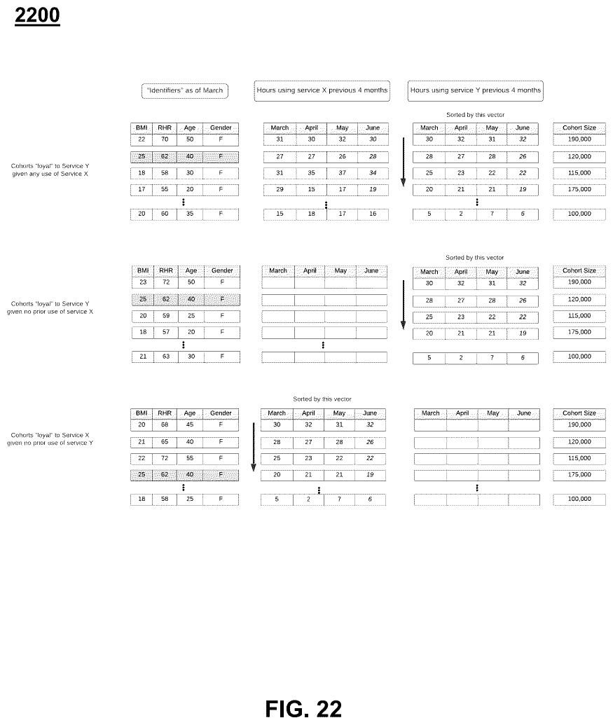

This five-stage embodiment of the anonymous targeted marketing process is detailed in FIGS. 22 (stage 1), 23 (stages 2 and 3) and 24 (stages 4 and 5). All three figures assume an illustrative use case wherein a vendor who sells two services, X and Y, is attempting to advertise service Y to the people using the system who are “most likely” to pay for the service and return as repeat (or “loyal”) customers. Importantly, this set of figures exemplifies an expected use-case where vendors are looking to expand into new markets. More specifically, vendors may attempt to reach new customers who will be “loyal” to a product or service in the future. All three figures further assume that this process is being executed during July of the current year, in this example.

FIG. 22 illustrates a diagram 2200 of an embodiment of a first stage of an anonymous, cohort-matched targeted advertising process, as implemented according to this disclosure. The first stage of the process may comprise target audience selection. In the depicted embodiment, audiences may be represented by a cluster (or cohort) centroid. As shown, centroid features may include attributes that represent, or encode, past behaviors or the state of a person at some point in the past. FIG. 22 illustrates an example of an initial selection of targeted audiences (Stage 1) based on a combination of personal attributes and past usage of either or both service(s) offered by the vendor. The first set of centroids may represent a subset of cohorts who have used both service X and service Y in the past. The down arrow to the left of the service Y utilization vector signifies a ranking or sorting of the cohort in descending order of total service Y utilization. This is meant to select for cohorts who are avid users of service Y and who are generally loyal to the vendor. It should be noted that no constraints are placed on the values of the “identifying” attributes. Also, it should be noted that these “identifying” attributes cannot in fact identify any individual since they are average values among very large cohorts. In this manner, the vendor may identify personal attributes that strongly correlate with service and vendor loyalty. The second set of centroids depicted may be considered to illustrate another audience enrichment strategy, whereby the vendor is intentionally selecting cohorts of people who have been loyal to service Y with no prior usage of service X. This may be considered an example of a control group, where the vendor checks for personal attributes that correlate strongly with service Y loyalty independent of any other service utilization. Those attribute sets may not appear in the previous set. Finally, the third set of centroids may be considered to illustrate a complement to the second set, wherein the vendor attempts to enrich cohorts who have been loyal to service X in the past without any history of service Y utilization. This may be considered another example of a control group, where the vendor checks for attributes that correlate strongly with vendor loyalty, rather than loyalty to a particular service or product.

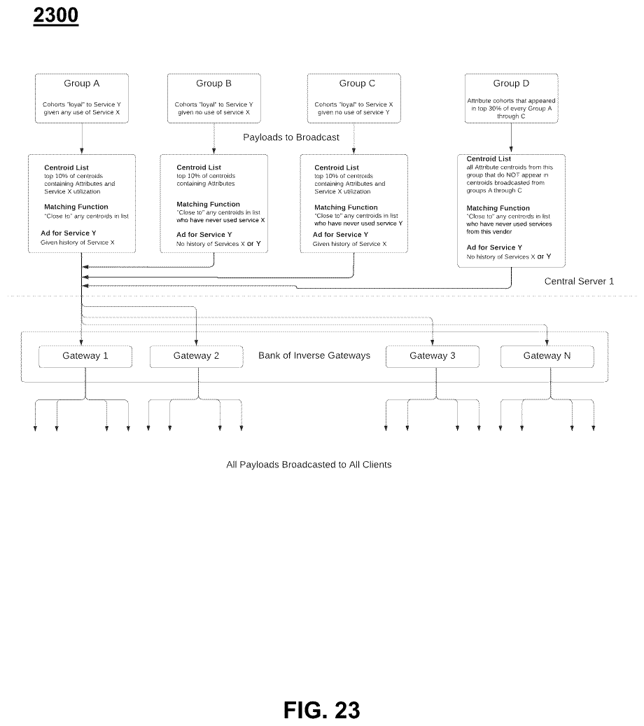

FIG. 23 illustrates a diagram 2300 of an embodiment of second and third stages of an anonymous, cohort-matched targeted advertising process, as implemented according to this disclosure. In this second stage (Stage 2) of the process, target audiences may be encoded or “serialized” in data packets or “payloads” that are destined to be broadcast across the entire network in the third stage. FIG. 23 depicts an embodiment of Stage 2 of the process in which distinct advertisements may be attached to each of the different target audiences selected in Stage 1. This depiction further illustrates a capability of attaching a specific matching function to each of the identified target audiences. FIG. 23 also depicts an embodiment of Stage 3 of the process whereby the Central Anonymized Server may send every payload to every Inverse Gateway device along with an instruction code that may translate to “Broadcast to all Clients”. The Inverse Gateways may then send a copy of every payload to every client IP that is stored in their local active-memory database.

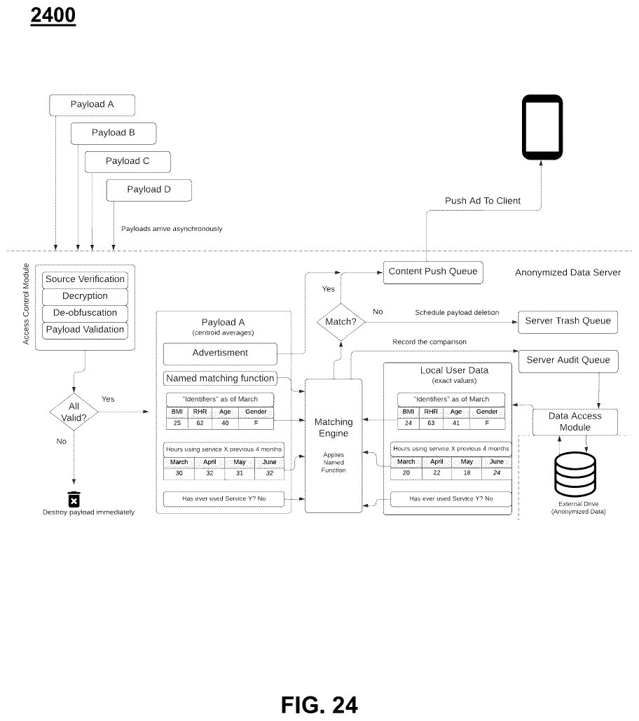

FIG. 24 illustrates a diagram 2400 of an embodiment of fourth and fifth stages of an anonymous, cohort-matched targeted advertising process, as implemented according to this disclosure. In this embodiment, the various advertising payloads (A through D) mayarrive at the user's Anonymous Data Server (“server”) asynchronously. In another embodiment, any incoming payload may be required to pass several tests that are executed by the Access Control Module of the server. If a payload is fully validated, then it may be sent to the server's Matching Engine. The Matching Engine may then call functions exposed internally by the Data Access Module to search for any internal models that match those defined in the payload. In the figure, this step is depicted by the Local User Data element being fed into the Matching Engine in tandem with the incoming payload. Once the Matching Engine has found any locally stored models that contain the appropriate attributes, the process may then check its own internal catalog of named matching functions to find the one named in the payload. If a matching function is found that is mapped to that name, the process may then invoke that function passing in both the payload and the local model as parameters. If the named matching function returns a successful match, then the advertisement contained in the payload may be sent to the server's Content Push Queue. The Content Push Queue may continually check its internal queue for the “next” content packet to be pushed to the user's client device and asynchronously delivers the next item in the queue.

In embodiments, the Central Anonymized Server may have access to all global cohort models that may be relevant to a particular vendor. By executing the cohort discovery process detailed above, the Learning Module of the Central Anonymized Server may automatically perform Stages 1 through 3 of the targeted marketing process, as illustrated in FIGS. 22 and 23. The only inputs that may be required from the vendor are the selection of product or service the vendor intends to advertise. The Learning Module may not have to constrain user “identifying” attribute vectors to any specific set of attributes as was done in FIG. 22. The Learning Module may simply constrain, and rank, all global centroids that include temporal vectors that encode utilization of service Y, or any other services/products sold by the vendor. The vendor is free to add more specificity or breadth to this automated process simply by adding or subtracting cohort attribute constraints including:
a. Utilization patterns for competing services from other vendors;
b. Specific sets of identifying attributes; and
c. Specific ranges of values for specific attributes (e.g., age groups).

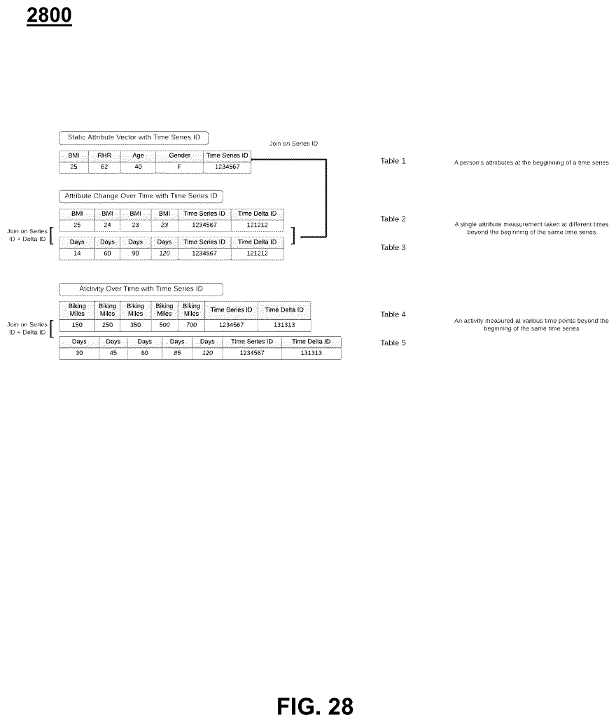

In FIG. 22, the timing of the attributes and activity may be encoded as a month, without a year, primarily for clarity of illustration. In other embodiments, timing may be encoded as temporal deltas from some unspecified starting datetime value with the addition of a time series identifier and sets of one or more time delta identifiers as detailed, for example, in FIG. 28. FIG. 28 illustrates an embodiment of a mechanism 2800 for encoding time series data anonymously. In this embodiment, time series data may be encoded as a composite of several vectors that are capable of associating any combination of the following data types to an arbitrary, unspecified starting point in time:
a. Static attributes of the user as they were at the chosen start time (e.g., user gender, user age, or the like);
b. Dynamic attributes that are being measured throughout the time series (e.g., Body Mass Index or “BMI”); and
c. Dynamic measures of activity that are being recorded throughout the time series.

As shown in FIG. 28, the identified association may be accomplished through a series of joins on two types of randomly generated identifiers that are both globally unique with respect to the user's Anonymized Data Server. One of those identifiers, an exemplary Time Series Identifier (or “Time Series ID”) may be generated to represent a chosen start date/time and thus may represent the time series as a whole. In embodiments, the Time Series ID may be present across all data structures associated with that time series. The second identifier may be a Time Delta Identifier (or “Time Delta ID”). This second identifier may be attached to any series of measurements that are meant to be considered together as a time series that began measurements at the chosen start date for the Time Series ID. For example, FIG. 28 depicts one time series for one person that associates several BMI measurements and biking mileage achieved across a 120 day period where the person's BMI at the start of that period was 25. Continuing the example, FIG. 28 depicts a series of four BMI measurements that were recorded by the user at 14 days, 60 days, 90 days and 120 days beyond the start date of the time series. Furthermore, a series of five biking mileage measurements is taken over the same time period, but at time points substantially distinct from those in the BMI series, specifically at 30 days, 45 days, 60 days, 85 days and 120 days beyond the start date, in this example. Through these mechanisms, the same person may be allowed the opportunity to associate asynchronous time points of arbitrary measurements across a same overall period, and all without revealing the actual dates of the events or measurements being recorded.

The targeted marketing use-case detailed above in FIGS. 22-24 is one example of the general capability of several embodiments of the disclosed system to:
a. push content to all clients along with
   i. a set of anonymous cohort attributes,
   ii. a named matching function to apply at the client side, and
   iii. a set of acceptance criteria or branching behaviors to execute conditioned on any outputs of the named matching function;
b. have a user's Anonymous Data Server apply the named matching function locally;
c. execute the behavior conditioned on the matching function outputs; and
d. deliver or “push” specific content to the client device conditioned on matching function outputs.

In FIGS. 22 through 24, the specific content mentioned in part (d) was an advertisement. In embodiments, the specific content to be pushed to the client device may be any form of electronic media, including video recordings, audio tracks or photographs. In embodiments, the content may be a set of instructions to be executed by the Application Logic Module on the client device. In embodiments, the content comprises recommendations for the user in which those recommendations may include links to content hosted on the system, notifications, or alerts to take an action, and/or notifications of upcoming events.

Embodiments may enable individual users to actively and anonymously find data to support a personal decision process. In embodiments, such a decision support process may be broken down as follows:
1. The system presents a User Interface that allows the user to define a personal goal;
2. The goal definition establishes relevant cohort attribute and activity parameters;
3. The parameters from 2. are used to find anonymous groups of people that have achieved the expressed goal at some point in the past;
4. Distributions of activity measurements may then be used to rank different activities in descending order of efficacy of those activities for achieving the expressed goal for at least two groups of people:
   a. People who are similar to the user, and
   b. A complement of the set of people identified in 4.a.

In embodiments, a third anonymous group may be presented to the user at step 4 in the process. This third anonymous group may include specifically people who are “dissimilar” to the user, where “dissimilar” can be defined as being in an inverse percentile when ranked by the relevant similarity metric. Succinctly stated, a case may be established in which a user is trying to find a best path forward toward a specific goal based on what has worked best for other people like themselves in the past heading towards the same goal.

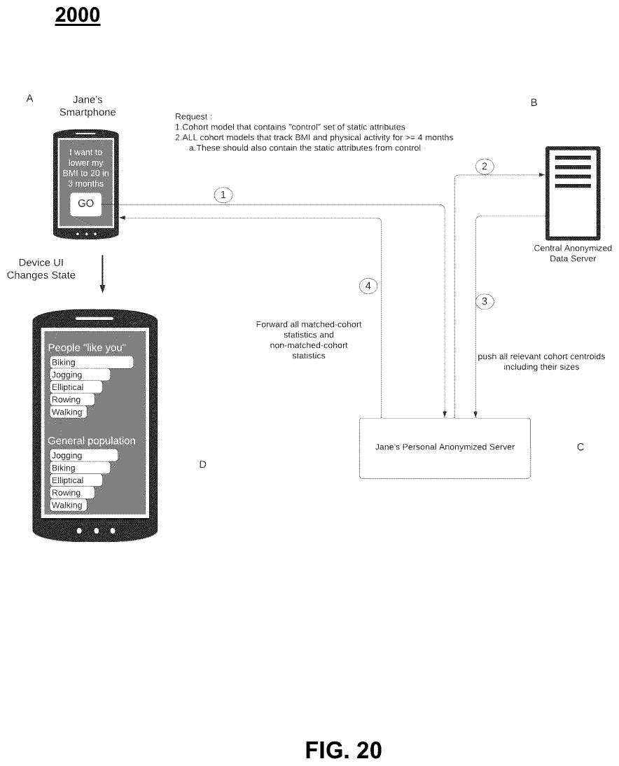

FIG. 20 schematically illustrates an anonymous cohort-matched decision support process 2000 as enabled by this disclosure. FIG. 20 details the high-level data flow supported by an embodiment. FIG. 20 (at “A”) depicts a user device (smart phone) belonging to a specific user of the system (“Jane”) displaying a personal goal that Jane has chosen for herself. Specifically, Jane decides she wants to lower her Body Mass Index to 20 over the next 3 months. When Jane taps the “GO” button depicted in FIG. 20 (at “A”), a request is sent (data flow 1) from the system application running on her phone to her personal Anonymized Data Server (see FIG. 20 (at “C”)). In embodiments, this initial request may include specifications for a control group having similar starting attributes to Jane's as well as all available cohort models that track BMI measurements for at least 4 consecutive months along with any activity measurements (e.g., mileage for running, biking, etc.). In embodiments, Jane's server may check all locally stored models that are relevant to the request and then forwards the request to the Central Anonymized Server (data flow 2) for all other relevant models that might be available. See FIG. 20 (at “B”). In embodiments, the Central Server may then perform a cohort matching process guided by the request parameters and may subsequently send all relevant cohort data back to Jane's personal server (data flow 3). In embodiments, Jane's personal server may then forward all relevant data back to her phone (data flow 4) which triggers a change in the state of the User Interface of Jane's device-resident application. See FIG. 20 (at “D”).

In embodiments, an initial request (data flow 1) may first be sent to Jane's Private Data Server. In the embodiments, the Private Data Server may cache all models that were of recent utility with respect to Jane's activity. In embodiments, requests for additional models may be sent to Jane's Anonymized Data Server from her Private Data Server, which are then immediately forwarded to the Central Anonymized Server. This embodiment assumes the model caching mechanisms shared between Private Data and Anonymized Data servers may be implemented as in FIG. 12.

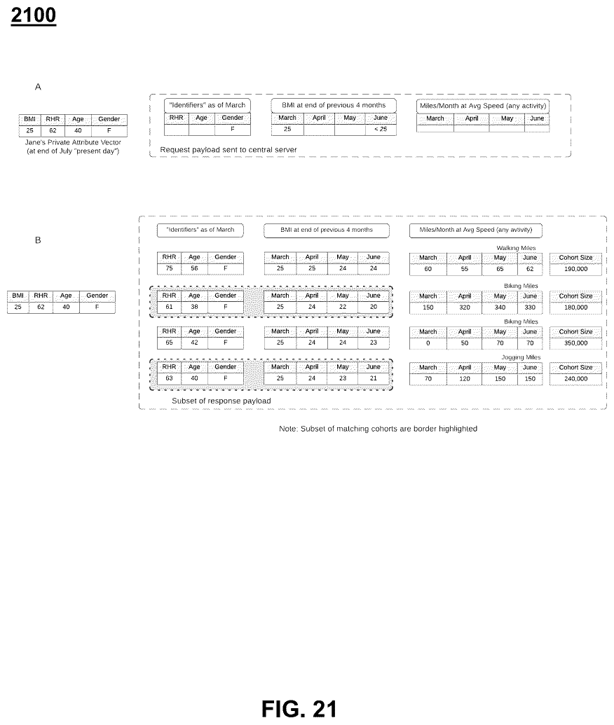

FIG. 21 illustrates a diagram 2100 of an exemplary cohort matching process. FIG. 21 continues to assume an example of user decision support depicted in FIG. 20. FIG. 21 details an embodiment of the cohort matching process that may be conducted on the Central Anonymized Server. FIG. 21 (at “A”) shows an example of an embodiment of the request data that may be sent in data flow 1 from FIG. 20. In the example, Jane's personal attributes (resting heart rate “RHR”, age and gender) may be used as a template for the attribute portion of the request payload. For instance, the gender attribute may be held constant at Female “F” in the payload vector. The parameters of Jane's defined goal may determine the remainder of the request payload. Continuing the example in FIG. 21 (at “A”), BMI as measured at the beginning of any potentially matched 4-month time series must be 25, which is Jane's current BMI. The BMI measured at the end of any potentially matched 4-month time series must be strictly <25 since Jane's goal is defined as a BMI of 20. Lastly, the activity portion of the payload may be left “open” to all activities stored on the system since Jane has not restricted that in any way. FIG. 21 (at “B”) depicts an embodiment of the matching process that is performed within the Learning Module on Jane's personal Anonymized Data Server. In this embodiment, the Learning Module may seek to rank all cohort vectors returned in the response payload coming from the Central Server (data flow 3 in FIG. 20) based on two distance metrics. Specifically, the parameters identified may be how close are the BMI time series centroids to Jane's desired BMI goal vector and then how close are the personal attribute centroids to Jane's current attributes. In embodiments, both metrics may be combined to form a single, global distance. Distances may be determined for every centroid set returned by the Central Server, and the centroid sets may be sorted in ascending order of distance, with the closest matches appearing at the top. In embodiments, the top 1% of the sum of all cohort sizes may be returned. In other embodiments, that percentile constraint may be relaxed to 5%, 10%, 20%, etc. In embodiments, all cohort centroids within some tolerated maximum distance are returned in the ranked list.

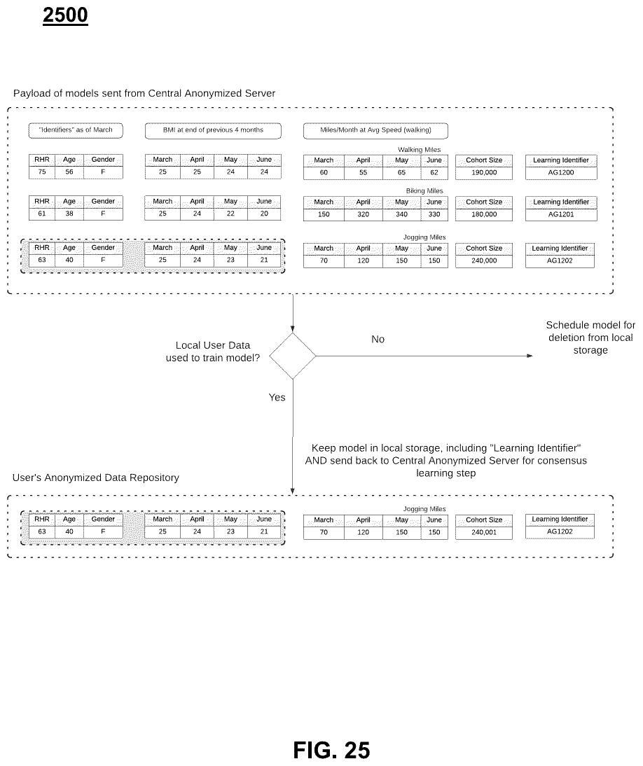

In embodiments, any model that closely matches or is otherwise derived from an individual user's anonymized data may be directly attributed to that user. In embodiments, the mechanisms that enable attribution of a model to a specific user include a “Learning Identifier”. The Learning Identifier may be a globally unique identifier of one iteration of federated learning in the larger system. FIG. 25 illustrates a diagram 2500 of an embodiment of a process of anonymously attributing an individual user's anonymized data as having contributed to building a global anonymous data model that has been constructed by a central system in the past. As illustrated in FIG. 25, when any cohort model is sent from the Central Anonymized Server to a client Anonymized Server and a local matching or learning process is executed, the privately educated model (or best matching model depending on the use case) may be stored in the client's local Anonymized Data Repository. The Learning Identifier may be stored along with the rest of the serialized model. The Learning Identifier may also be depicted in the model serialization example in FIG. 16.

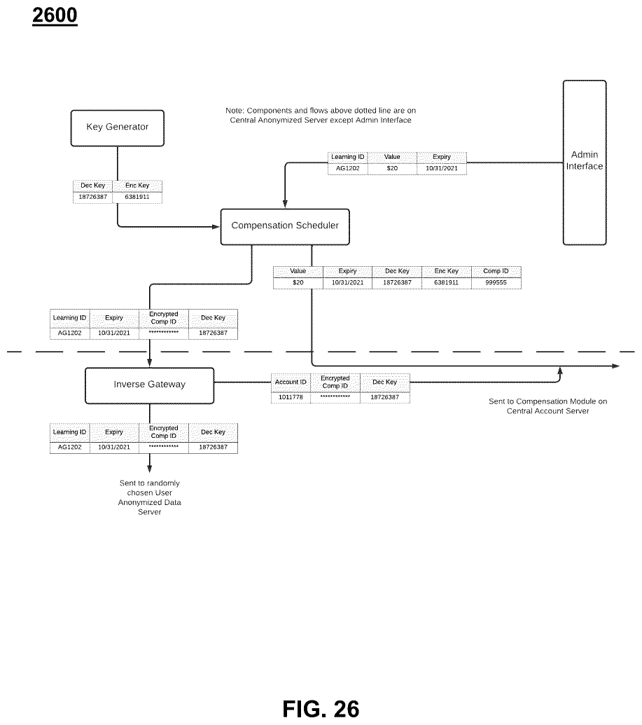

Embodiments may comprise mechanisms that allow for individual users to be financially compensated for use of their anonymized data which, as has been detailed herein, may be a derivative of the user's private data. In embodiments, these mechanisms may include a “Compensation Scheduler”, encryption “Key Generator” and an “Administrative Interface” (or “Admin Interface”). The role and functioning of these mechanisms are detailed in FIG. 26. For example, FIG. 26 illustrates a diagram 2600 of an embodiment of a process of key generation executed in support of anonymous data utility determinations. The Admin Interface may comprise both a graphical user interface and a developer API that may allow system users with administrative access privileges to explicitly assign dollar values to any data model stored in the bank of Central Anonymized Servers. The Admin Interface may further comprise a database that maps every existing model to every iteration of federated learning that has been executed to build that model. This mapping may be accomplished by storing a record that directly associates the model with one or more Learning Identifiers. The Key Generator may continually generate pairs of random, asymmetric encryption keys, one for encryption and the other for decryption. Once a dollar value has been assigned to a specific learning iteration and given an expiry, that information may be sent to the Compensation Scheduler. In embodiments, the Compensation Scheduler (“scheduler”) may be an automated, but extensible software module that continually processes, for example, two input streams and generates two output streams. One input stream may originate from the Admin Interface and the other from the Key Generator. The scheduler may then generate two output streams with one data packet generated per output stream per incoming Learning Identifier. In an embodiment, the output stream that is sent to the Central Account Server may contain data packets (or “tuples”) comprising a structure as, for example detailed in FIG. 26, including a dollar amount of compensation per user, the expiry of this compensation event, both of the asymmetric encryption keys from the Key Generator as well as a randomly generated, globally unique “Compensation Identifier” (“Comp ID” in the figure). In embodiments, the second stream may be sent to any one of the Inverse Gateway devices and may contain data packets comprising a structure as detailed in FIG. 26 including the Learning Identifier, the expiry for the compensation event, the encrypted version of the Comp ID, and the decryption key. In an embodiment, the scheduler may perform the encryption of the Comp ID prior to creating this data packet.

In embodiments, the Inverse Gateway device may generate two output streams from the input stream it receives from the scheduler. This is also depicted in FIG. 26. In embodiments, one of the output streams may represent a repackaging of the input stream received from the scheduler comprising all the data packet fields from the input stream (intact) with the addition of any necessary headers or ancillary fields required for successful transmission of the data packet to a specific user's Anonymized Data Server (additional fields not depicted). In embodiments, the Inverse Gateway may randomly choose the destination IP address from its database of Anonymized Data Server addresses held in active memory. In embodiments, after the Inverse Gateway chooses a destination IP address, it may then create a new data packet comprising the Account Identifier associated with the chosen IP address, the encrypted Comp ID and the decryption key. It may then send this packet to the Central Account Server to be processed by the Compensation Module.

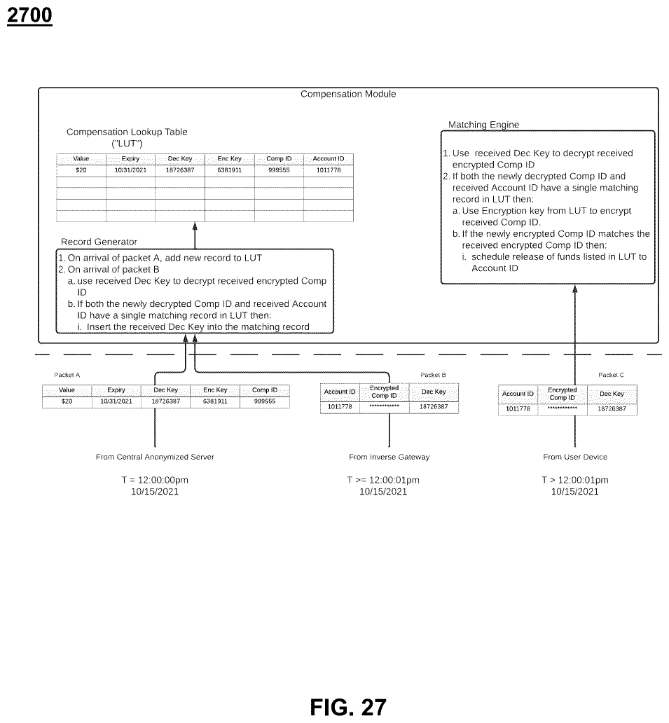

FIG. 27 illustrates a diagram 2700 of a software architecture and operation of an embodiment of a Compensation Module, by way of an illustrative example, including sub-components thereof and pseudocode listings for internal processes. Several embodiments may include a Compensation Module. One embodiment of the Compensation Module, as depicted in FIG. 27, comprises three subcomponents including a Matching Engine, Record Generator, and a Compensation Lookup Table (“LUT”). In this embodiment, the Compensation module may receive three separate data streams asynchronously. The relative timings of the three incoming data streams are important and this is indicated in the figure by way of expected arrival times of three examples of their respective data packets—Packets A, B and C—all corresponding to a single compensation event. Packet A comprises all the data that defines a round of compensation that is expected to commence at some point in the near future (in contrast to a single compensation event). Packet A may originate from the Compensation Scheduler on the Central Anonymized Server. Packet B may arrive soon after Packet A and originate from the Inverse Gateway. In an embodiment, Packet B may be ensured to arrive after Packet A because the Compensation Scheduler may wait until it receives a confirmation message from the Compensation Module prior to sending any further information to an Inverse Gateway. Packet C may arrive last and originate from a user device (smart phone, laptop, etc).

In embodiments, a Record Generator may follow a two stage process triggered by the asynchronous arrival of either of the two expected data packet types (A or B). As detailed in FIG. 27, in an embodiment, this two stage process may proceed according to the following listing:
1. On arrival of packet A, add new record to LUT; and
2. On arrival of packet B
   a. a received Dec Key may be used to decrypt received encrypted Comp ID; and
   b. if both the newly decrypted Comp ID and the received Account ID have a single matching record in LUT then:
      i. Insert the received Dec Key into the matching record.

In embodiments, the Matching Engine may follows a two stage process triggered by the asynchronous arrival of data packet type C received from authenticated user devices. As detailed in FIG. 27, in an embodiment, this two stage process may proceed according to the following listing:
1. Use received Dec Key to decrypt received encrypted Comp ID;
2. If both the newly decrypted Comp ID and received Account ID have a single matching record in LUT then:
   a. Use Encryption key from LUT to encrypt received Comp ID, and.
   b. If the newly encrypted Comp ID matches the received encrypted Comp ID then schedule release of funds listed in LUT to Account ID.

The disclosed embodiments may include a non-transitory computer-readable medium storing instructions which, when executed by a processor may cause the processor to execute all, or at least some, of the functions outlined above.

Although depicted in a particular sequence, it should be noted that the enumerated steps of any of the methods outlined are not necessarily limited to the order described. The steps of the exemplary disclosed methods may be, for example, executed in any manner limited only where the execution of any particular method step provides a necessary precondition to the execution of a subsequent method step.

Although the above description may contain specific details as to one or more of the overall objectives of the disclosed schemes, and exemplary overviews of systems and methods for carrying into effect those objectives, these details should be considered as illustrative only, and not construed as limiting the disclosure in any way. Other configurations of the described embodiments may properly be considered to be part of the scope of the disclosed embodiments. For example, the principles of the disclosed embodiments may be applied to each individual user, identified groups of users, entity or entities where each user, user group or entity may individually access features of the disclosed solutions, as needed, according to one or more of the multiply discussed configurations. This enables each user to make full use of the benefits of the disclosed embodiments even if any one of a large number of possible applications do not need all of the described functionality. In other words, there may be multiple instances of the disclosed systems, methods and devices each being separately employed in various possible ways at the same time where the actions of one user do not necessarily affect the actions of other users using separate and discrete embodiments.

Other configurations of the described embodiments of the disclosed systems and methods are, therefore, part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A system for sharing user data, comprising:
a data storage device for storing user data; and
a server that is configured to
establish communications with the data storage device and with a plurality of user devices;
accept first user data from a plurality of first users, the first user data being input by the first users' user devices and communicated to the server;
segregate first user private data from the accepted first user data for each first user;
securely store the first user private data in the data storage device;
anonymize attributes of the first user data to provide anonymized first user data;
separately store the anonymized first user data in the data storage device;
receive a request for information from a second user on a first user population according to specified attributes, wherein the request is communicated to the server via the second user's user device;
compile a response to the request for information on the first user population according to the specified attributes; and
output the compiled response to the second user's user device in reply to the request.

2. The system of claim 1, wherein the server anonymizes the attributes of the first user data to provide the anonymized first user data according to a prescribed anonymization scheme that completely masks access to the first user private data.

3. The system of claim 2, wherein the server is further configured to apply a separate encryption scheme to at least a portion of the first user private data.

4. The system of claim 2, wherein the server is further configured to apply a separate obfuscation scheme to at least a portion of the first user private data.

5. The system of claim 1, wherein the anonymized first user data is sortable according to the attributes.

6. The system of claim 1, wherein identification of first user private data is selectable by each first user.

7. The system of claim 1, wherein identification of first user private data is according to a prescribed scheme.

8. The system of claim 1, wherein the attributes are selectable by each first user.

9. The system of claim 1, wherein the server is further configured to group the anonymized data for the plurality of first users according to the attributes.

10. The system of claim 1, wherein at least one of the attributes has a range of numeric values associated with the at least one of the attributes.

11. The system of claim 10, wherein the server is further configured to group the anonymized data according to discrete sub-ranges for the range of numeric values associated with the at least one of the attributes.

12. The system of claim 10, wherein the server is further configured to group the anonymized data according to percentiles of the first user population falling within the sub-ranges for the range of numeric values associated with the at least one of the attributes.

13. The system of claim 10, wherein the server is further configured to access publicly available data to bound the range of numeric values associated with the at least one of the attributes.

14. A method for sharing user data, comprising:
establishing communications between a server and a data storage device;
establishing communications between a server and a plurality of user devices;
accepting, with the server, first user data from a plurality of first users, the first user data being input by the first users' user devices and communicated to the server;
segregating, with the server, first user private data from the accepted first user data for each first user;
securely storing, with the server, the first user private data in the data storage device;
anonymizing attributes of the first user data, with the server, to provide anonymized first user data;
separately storing, with the server, the anonymized first user data in the data storage device;
receiving, with the server, a request for information from a second user on a first user population according to specified attributes, wherein the request is communicated to the server via the second user's user device;
compiling, with the server, a response to the request for information on the first user population according to the specified attributes; and
outputting from the server the compiled response via communication with the second user's user device in reply to the request.

15. The method of claim 14, wherein the server anonymizes the attributes of the first user data to provide the anonymized first user data according to a prescribed anonymization scheme that completely masks access to the first user private data.

16. The method of claim 15, wherein the server is further configured to apply a separate encryption scheme to at least a portion of the first user private data.

17. The method of claim 15, wherein the server is further configured to apply a separate obfuscation scheme to at least a portion of the first user private data.

18. The method of claim 14, wherein the anonymized first user data is sortable according to the attributes.

19. The method of claim 14, wherein identification of first user private data is selectable by each first user.

20. The method of claim 14, wherein identification of first user private data is according to a prescribed scheme.
